(19) United States
(12) Patent Application Publication
(10) Pub. No.: US 2019/0079304 A1
(43) Pub. Date: Mar. 14, 2019

(54) HALF MIRROR AND MIRROR WITH IMAGE DISPLAY FUNCTION

(71) Applicant: FUJIFILM Corporation, Tokyo (JP)

(72) Inventors: Hirotoshi ANDO, Minamiashigara-shi (JP); Takao TAGUCHI, Minamiashigara-shi (JP); Mikio TOMARU, Minamiashigara-shi (JP)

(73) Assignee: FUJIFILM Corporation, Tokyo (JP)

(21) Appl. No.: 16/178,939

(22) Filed: Nov. 2, 2018

Related U.S. Application Data
(63) Continuation of application No. PCT/JP2017/021699, filed on Jun. 12, 2017.

(30) Foreign Application Priority Data
Jun. 21, 2016 (JP) 2016-122675
May 31, 2017 (JP) 2017-108085

(51) Int. Cl. G02B 27/14; G02B 5/08; B60R 1/12; B60R 1/04

(52) U.S. Cl. CPC G02B 27/144; G02B 5/0808; B60R 2001/1253; B60R 1/04; B60R 1/12

(57) ABSTRACT

A half mirror includes an observation surface, a molded resin layer, and a polarization reflection plate in this order, at least one high-Re retardation film is included between the observation surface and the polarization reflection plate, a total front phase difference of the high-Re retardation film is 3,000 nm or greater, and a first high-Re retardation film is included as the high-Re retardation film between the observation surface and the molded resin layer.

### CROSS-REFERENCE TO RELATED APPLICATIONS

This application is a Continuation of PCT International Application No. PCT/JP2017/021699, filed on Jun. 12, 2017, which claims priority under 35 U.S.C. § 119(a) to Japanese Patent Application No. 2016-122675, filed on Jun. 21, 2016, and Japanese Patent Application No. 2017-108085, filed on May 31, 2017. Each of the above application(s) is hereby expressly incorporated by reference, in its entirety, into the present application.

### BACKGROUND OF THE INVENTION

### 1. Field of the Invention

The present invention relates to a half mirror and a mirror with an image display function including the half mirror.

### 2. Description of the Related Art

For example, in JP2014-201146A, a vehicle mirror with an image display function is described which is capable of displaying images such as images taken by a car-mounted camera on the vehicle mirror. In the vehicle mirror with an image display function disclosed in JP2014-201146A, a liquid crystal display device is provided inside a housing of the vehicle mirror to display an image through a half mirror provided on a front surface of the vehicle mirror, thereby realizing image display on the mirror.

JP2011-045427A discloses, as a mirror with a display function, a mirror with an information display function which is applied to a mirror for interior decoration purpose, cosmetic purpose, security purpose, or safety purpose, and using a polarization reflection plate as a half mirror is described therein.

As a method of manufacturing a mirror, a method of thermally pressure-bonding a reflection film on a resin layer obtained by injection molding has been known as described in JP2004-286943A.

### SUMMARY OF THE INVENTION

In a case where a metal-deposited mirror or the like is used as the half mirror in the vehicle mirror with an image display function described in JP2014-201146A, there is a potential problem in that the visible light transmittance is about 30% to 70%, and thus images are displayed darker than those displayed on a mirror having no half mirror.

Light loss can be eliminated using a polarization reflection plate described in JP2011-045427A. Accordingly, the inventors produced a half mirror in which a polarization reflection plate is provided on a surface of a resin layer obtained by injection molding as described in JP2004-286943A. However, brightness unevenness was confirmed in a case where a mirror-reflected image of the obtained half mirror was observed through polarizing sunglasses. In addition, brightness unevenness or color unevenness (rainbow unevenness or the like) was confirmed also in an image of a mirror with an image display function produced using the half mirror in a case where the image was observed through polarizing sunglasses.

An object of the invention is to provide a half mirror which provides a mirror-reflected image having no unevenness as a half mirror having a configuration in which a polarization reflection plate is provided on a resin layer molded by processing including heating and pressing. Another object of the invention is to provide a mirror with an image display function which provides a bright image having no unevenness together with a mirror-reflected image having no unevenness as a mirror with an image display function including the half mirror having a configuration in which a polarization reflection plate is provided on a resin layer molded by processing including heating and pressing.

The inventors have conducted intensive studies in order to achieve the object, and completed the invention.

The invention provides the following [1] to [19].

[1] A half mirror comprising in order: an observation surface; a molded resin layer; and a polarization reflection plate, in which at least one high-Re retardation film is included between the observation surface and the polarization reflection plate, a total front phase difference of the high-Re retardation film is 3,000 nm or greater, and a first high-Re retardation film is included as the high-Re retardation film between the observation surface and the molded resin layer.

[2] The half mirror according to [1], in which a front phase difference distribution of the molded resin layer is 100 nm or greater.

[3] The half mirror according to [1] or [2], in which a total front phase difference of the high-Re retardation film is 5,000 nm or greater.

[4] The half mirror according to any one of [1] to [3], in which a front phase difference of the first high-Re retardation film is 3,000 nm or greater.

[5] The half mirror according to any one of [1] to [4], in which only the first high-Re retardation film is included as the high-Re retardation film.

[6] The half mirror according to any one of [1] to [4], in which as the high-Re retardation film, a second high-Re retardation film is further included between the molded resin layer and the polarization reflection plate.

[7] The half mirror according to [6], in which a slow axis direction of the first high-Re retardation film is the same as a slow axis direction of the second high-Re retardation film.

[8] The half mirror according to [6] or [7], in which an adhesive layer or a thermoplastic welding layer is included between the second high-Re retardation film and the molded resin layer.

[9] The half mirror according to any one of [1] to [8], in which the molded resin layer includes at least one polymer selected from the group consisting of polycarbonate, poly(meth)acrylate, polyester, and a cycloolefin polymer.

[10] The half mirror according to any one of [1] to [9], in which the polarization reflection plate is a circular polarization reflection layer.

[11] The half mirror according to [10], in which the circular polarization reflection layer includes a cholesteric liquid crystal layer.

[12] The half mirror according to [11], in which the circular polarization reflection layer includes three or more cholesteric liquid crystal layers.

[13] The half mirror according to any one of [10] to [12], further comprising: a ¼ wavelength plate, in which the molded resin layer, the polarization reflection plate, and the ¼ wavelength plate are included in this order.

[14] The half mirror according to [13], in which the polarization reflection plate and the ¼ wavelength plate are in direct contact with each other.

[15] The half mirror according to any one of [1] to [14], in which an adhesive layer or a thermoplastic welding layer is included between the molded resin layer and the polarization reflection plate.

[16] The half mirror according to any one of [1] to [15], in which an adhesive layer or a thermoplastic welding layer is included between the first high-Re retardation film and the molded resin layer.

[17] A mirror with an image display function comprising: the half mirror according to any one of [1] to [16]; and an image display device, in which the observation surface, the molded resin layer, the polarization reflection plate, and the image display device are disposed in this order.

[18] The mirror with an image display function according to [17], in which the image display device emits linearly polarized light to form an image, the image display device has a backlight which provides a continuous emission spectrum, and a slow axis of the first high-Re retardation film forms an angle of 30° to 60° with a polarization direction of the linearly polarized light.

[19] The mirror with an image display function according to [18], in which the image display device is a liquid crystal display device, and the backlight is a white LED.

According to the invention, it is possible to provide a half mirror which provides a mirror-reflected image having no unevenness as a half mirror having a configuration in which a polarization reflection plate is provided on a resin layer molded by processing including heating and pressing. It is also possible to provide a mirror with an image display function which provides a bright image having no unevenness together with a mirror-reflected image having no unevenness as a mirror with an image display function including the half mirror having a configuration in which a polarization reflection plate is provided on a resin layer molded by processing including heating and pressing.

### DESCRIPTION OF THE PREFERRED EMBODIMENTS

Hereinafter, the invention will be described in detail.

In this specification, “to” is used to mean that numerical values before and after “to” are included as a lower limit value and an upper limit value.

In this specification, an angle such as “45°”, “parallel”, “vertical”, or “perpendicular” means that a difference from an exact angle is in a range less than 5° unless otherwise stated. The difference from an exact angle is preferably less than 4°, and more preferably less than 3°.

In this specification, “(meth)acrylate” means “one or both of acrylate and methacrylate”. “Poly(meth)acrylate” is also used in the same manner.

In this specification, in a case where “selectively” is used in regard to circularly polarized light, it means that the light quantity of any one of a right circular polarization component or a left circular polarization component is greater than that of the other circular polarization component. Specifically, when “selectively” is used, the circular polarization degree of light is preferably 0.3 or greater, more preferably 0.6 or greater, and even more preferably 0.8 or greater. Substantially, the circular polarization degree is yet even more preferably 1.0. Here, the circular polarization degree is a value which is expressed by |I_{R}−I_{L}|/(I_{R}+I_{L}) where the intensity of a right circular polarization component of light is represented by I_{R}, and the intensity of a left circular polarization component is represented by I_{L}.

In this specification, when “sense” is used in regard to circularly polarized light, it means that the light is either right-circularly polarized light or left-circularly polarized light. The sense of circularly polarized light is defined such that, in a case where light is viewed as it proceeds toward an observer and in a case where the tip of an electric field vector rotates clockwise with the increase in time, the light is right-circularly polarized light, and in a case where it rotates counterclockwise, the light is left-circularly polarized light.

In this specification, the term “sense” may be used in regard to a twisted direction of the helix of cholesteric liquid crystal. In a case where a twisted direction (sense) of the helix of the cholesteric liquid crystal is right-handed, the right-circularly polarized light is reflected and the left-circularly polarized light is transmitted. In a case where the sense of the helix of the cholesteric liquid crystal is left-handed, the left-circularly polarized light is reflected, and the right-circularly polarized light is transmitted.

In this specification, the front phase difference is a value measured using AxoScan manufactured by Axometrics, Inc. The measurement wavelength is 550 nm unless otherwise stated. As the front phase difference, a value measured by making light with a wavelength in a visible light wavelength region, such as a central wavelength of selective reflection of a cholesteric liquid crystal layer, incident in a film normal direction in KOBRA 21ADH or WR (manufactured by Oji Scientific Instruments) can also be used. In the selection of the measurement wavelength, a wavelength selective filter can be manually replaced, or the measured value can be converted by a program or the like for measurement. In this specification, the front phase difference may be referred to as “Re”.

In this specification, when “mirror-reflected image” is used, it means an image which is observed based on the reflection from the half mirror. The mirror-reflected image may be observed on an observation surface. In this specification, when “image” is used, it means an image derived from an image of an image display device or an image of an image display device observed on a mirror with an image display function when the image is displayed on an image display portion of the image display device.

<<Half Mirror>>

In this specification, the half mirror means a mirror having a function of reflecting light and a function of transmitting at least a part of light with a desired wavelength.

A half mirror according to the embodiment of the invention includes an observation surface, a molded resin layer, and a polarization reflection plate in this order, and further includes a high-Re retardation film. The half mirror may also include other layers such as an optical functional layer, an adhesive layer, and a thermoplastic welding layer.

In the half mirror according to the embodiment of the invention, an outermost surface which is on the molded resin layer side as viewed from the polarization reflection plate may serve as an observation surface. In this specification, the observation surface is a surface on the side on which a mirror-reflected image is observed, and means the reflection surface of the half mirror.

The shape of the half mirror is not particularly limited as long as it is suited to the intended use. The shape of the half mirror is preferably a plate shape or a film shape. The half mirror may have a curved surface. That is, the half mirror may be flat or curved. Particularly, the curved shape can be designed with a free-form surface such as a polynomial aspheric surface or a Zernike polynomial surface other than a spherical surface depending on necessary optical performance. In a case where the half mirror is for use in a vehicle mirror or the like, a shape in which the observation surface is a convex surface is preferable.

<Molded Resin Layer (Molten Resin)>

In this specification, the molded resin layer means a resin layer molded by processing including heating and pressing. The molded resin layer is preferably obtained by injection molding. The method of producing a molded resin layer will be described later.

The shape of the molded resin layer is not particularly limited. The shape of the molded resin layer is preferably a plate shape or a film shape. The molded resin layer may have a curved surface. That is, the molded resin layer may be flat or curved.

In the half mirror according to the embodiment of the invention, a layer which is transparent in a visible light region is used as the molded resin layer. Here, transparent in a visible light region refers to that the light transmittance in a visible light region is 80% or greater, and preferably 85% or greater. The light transmittance used as a measure of transparency can be obtained by the method described in JIS A 5759. That is, the transmittance at a wavelength of 380 nm to 780 nm is measured with a spectrophotometer, and multiplied by a weighting factor obtained from the spectral distribution of the CIE (International Commission on Illumination) illuminant D65, the wavelength distribution of the CIE light adaptation spectral luminous efficiency, and the wavelength interval, and a weighted average thereof is obtained to obtain the light transmittance.

The molded resin layer is likely to have non-uniform birefringence due to the processing including heating and pressing. For example, the front phase difference distribution of the molded resin layer is preferably 50 nm or greater, and particularly preferably 100 nm or greater. In addition, the front phase difference distribution of the molded resin layer is preferably at most about 500 nm. Here, as shown in examples, the front phase difference distribution is obtained by measuring the front phase difference of a measurement object divided into nine equal parts and calculating the difference between the maximum value and the minimum value.

The thickness of the molded resin layer may be about 100 μm to 10 mm, preferably 200 μm to 5.0 mm, more preferably 500 μm to 4.0 mm, and still more preferably 1.0 mm to 3.0 mm.

Examples of the material for forming a molded resin layer include thermoplastic resins and thermosetting resins. In a case where a thermosetting resin is used, the material for forming a molded resin layer may contain a monomer having a polymerizable group. A thermoplastic resin is preferable as the material for forming a molded resin layer. The material for forming a molded resin layer is preferably a resin which is generally used for injection molding since the material is, for example, a resin to be injected into a mold in the manufacturing of the molded resin layer. The material for forming a molded resin layer is used as a molten resin heated to a temperature equal to or higher than the melting point in the formation of the molded resin layer.

Examples of the thermoplastic resins include polycarbonates (PC), poly(meth)acrylates, polyesters such as polyethylene terephthalate (PET), and cycloolefin polymers (COP). Examples of the thermosetting resins include phenolic resins, epoxy resins, melamine resins, urea resins, unsaturated polyester resins, diallyl phthalate resins, polyurethane resins, and silicone resins.

Among these, polycarbonates, poly(meth)acrylates, polyesters, or cycloolefin polymers are preferable, poly(meth)acrylates or polycarbonates are more preferable, and polycarbonates are even more preferable as the material for forming a molded resin layer.

Examples of commercially available thermoplastic resins include IUPILON S3000 1 (polycarbonate, manufactured by Mitsubishi Engineering-Plastics Corporation), NOVAREX 7022-1 (polycarbonate, manufactured by Mitsubishi Engineering-Plastics Corporation), SUMIPEX MG5 (poly(meth)acrylate, manufactured by Sumitomo Chemical Co., Ltd.), PETG K2012 (polyethylene terephthalate, manufactured by Eastman Chemical Company), ZEONEX E48R (cycloolefin polymer, manufactured by ZEON CORPORATION), PANLITE L-1250Z100 (polycarbonate, TEIJIN LIMITED.), and DURBIO T744OIR (polycarbonate, manufactured by Mitsubishi Chemical Corporation).

<Polarization Reflection Plate: Linear Polarization Reflection Layer>

Examples of the polarization reflection plate include a linear polarization reflection layer and a circular polarization reflection layer.

Examples of the linear polarization reflection layer include (i) linear polarization reflection plate having a multilayer structure, (ii) polarizer including a laminate of thin films having different types of birefringence, (iii) wire grid polarizer, (iv) polarizing prism, and (v) scattering anisotropic polarizing plate.

Examples of (i) linear polarization reflection plate having a multilayer structure include a laminate of a plurality of dielectric thin films having different refractive indices. In order to form a wavelength-selective reflection film, it is preferable that a dielectric thin film having a high refractive index and a dielectric thin film having a low refractive index be alternately laminated in a plurality of layers. However, the number of film types is not limited to two, and three or more types of films may be used. The number of layers to be laminated is preferably 2 to 20, more preferably 2 to 12, even more preferably 4 to 10, and particularly preferably 6 to 8. In a case where the number of layers to be laminated is not greater than 20, it is possible to prevent production efficiency from being reduced due to multilayer vapor deposition.

The lamination order of the dielectric thin films is not particularly limited, and can be appropriately selected in accordance with the purpose. For example, in a case where an adjacent film has a high refractive index, a film having a lower refractive index than the above film is laminated first. In contrast, in a case where an adjacent layer has a low refractive index, a film having a higher refractive index than the above film is laminated first. The indication of the boundary between high and low refractive indices is 1.8. The level of the refractive index is not absolute, and among materials having a high refractive index, a material having a relatively high refractive index and a material having a relatively low refractive index may be present, and these may be alternately used.

Examples of the material of a dielectric thin film having a high refractive index include Sb₂O₃, Sb₂S₃, Bi₂O₃, CeO₂, CeF₃, HfO₂, La₂O₃, Nd₂O₃, Pr₆O₁₁, Sc₂O₃, SiO, Ta₂O₅, TiO₂, TlCl, Y₂O₃, ZnSe, ZnS, and ZrO₂. Among these, Bi₂O₃, CeO₂, CeF₃, HfO₂, SiO, Ta₂O₅, TiO₂, Y₂O₃, ZnSe, ZnS, and ZrO₂ are preferable, and SiO, Ta₂O₅, TiO₂, Y₂O₃, ZnSe, ZnS, and ZrO₂ are particularly preferable.

Examples of the material of a dielectric thin film having a low refractive index include Al₂O₃, BiF₃, CaF₂, LaF₃, PbCl₂, PbF₂, LiF, MgF₂, MgO, NdF₃, SiO₂, Si₂O₃, NaF, ThO₂, and ThF₄. Among these, Al₂O₃, BiF₃, CaF₂, MgF₂, MgO, SiO₂, and Si₂O₃ are preferable, and Al₂O₃, CaF₂, MgF₂, MgO, SiO₂, and Si₂O₃ are particularly preferable.

In the material of a dielectric thin film, the atomic ratio is not particularly limited, and can be appropriately selected in accordance with the purpose, and the atomic ratio can be adjusted by changing the concentration of an atmospheric gas in the film formation.

The method of forming a dielectric thin film is not particularly limited, and can be appropriately selected in accordance with the purpose. Examples thereof include physical vapor deposition methods (PVD methods) such as ion plating, vacuum vapor deposition using ion beams, and sputtering, and chemical vapor deposition methods (CVD methods). Among these, vacuum vapor deposition and sputtering are preferable, and sputtering is particularly preferable.

DC sputtering with a high deposition rate is preferable as the sputtering. In the DC sputtering, a material having high conductivity is preferably used.

As a method of forming a multilayer film by sputtering, for example, (1) one-chamber method in which films are alternately or sequentially formed from a plurality of targets in one chamber, and (2) multichamber method in which films are continuously formed in a plurality of chambers. Among these, a multichamber method is particularly preferable from the viewpoint of productivity and prevention of material contamination.

The thickness of the dielectric thin film is preferably λ/16 to λ, more preferably λ/8 to 3λ/4, and even more preferably λ/6 to 3λ/8 in optical wavelength order.

The light propagating in a dielectric vapor deposition layer partially undergoes multiple reflections for each dielectric thin film, and by the interference of the reflected light, only the light with a wavelength determined by the product of the thickness of the dielectric thin film and the refractive index of the film with respect to the light is selectively transmitted. In addition, the central transmission wavelength of the dielectric vapor deposition layer has angle dependence with respect to incident light, and in a case where the incident light is changed, the transmission wavelength can be changed.

As (ii) polarizer including a laminate of thin films having different types of birefringence, for example, a polarizer described in JP1997-506837A (JP-H9-506837A) or the like can be used. Specifically, in a case where processing is performed under conditions selected to obtain a specific refractive index relationship, it is possible to form a polarizer by using a wide variety of materials. In general, one first material preferably has a refractive index different from that of a second material in a selected direction. The difference in the refractive index can be achieved by various methods including stretching during or after film formation, extrusion molding, or coating. Moreover, in order to coextrude two materials, the materials preferably have similar rheological characteristics (for example, melt viscosity).

As the polarizer including a laminate of thin films having different types of birefringence, commercially available products can be used, and examples thereof include DBEF (registered trademark) (manufactured by 3M Company).

(iii) Wire grid polarizer is a polarizer which transmits one component of polarized light and reflects the other component thereof by birefringence of fine metal wires.

The wire grid polarizer is obtained by periodically arranging metal wires, and is used as a polarizer mainly in a terahertz wavelength band. In order to allow the wire grids to function as a polarizer, the interval between wires is preferably sufficiently smaller than the wavelength of the incident electromagnetic waves.

In the wire grid polarizer, metal wires are arranged at the same intervals. A polarization component in a polarization direction parallel to a longitudinal direction of the metal wires is reflected from the wire grid polarizer, and a polarization component in a polarization direction perpendicular thereto is transmitted through the wire grid polarizer.

As the wire grid polarizer, commercially available products can be used, and examples thereof include a wire grid polarizing filter 50×50, NT46-636, manufactured by Edmund Optics GmbH Germany.

<Polarization Reflection Plate: Circular Polarization Reflection Layer>

Using a circular polarization reflection layer, incident light from the molded resin layer side can be reflected as circularly polarized light. In addition, in a case where the half mirror is used for a mirror with an image display function, incident light from an image display device can be transmitted as circularly polarized light. Therefore, in the half mirror using the circular polarization reflection layer and the mirror with an image display function using the half mirror, it is possible to observe an image and a mirror-reflected image even through polarizing sunglasses without depending on the direction.

Examples of the circular polarization reflection layer include a lamination-type circular polarization reflection layer including a linear polarization reflection plate and a ¼ wavelength plate, and a cholesteric circular polarization reflection layer including a cholesteric liquid crystal layer.

[Lamination-Type Circular Polarization Reflection Layer Including Linear Polarization Reflection Plate and ¼ Wavelength Plate]

In the lamination-type circular polarization reflection layer, the linear polarization reflection plate and the ¼ wavelength plate may be disposed such that the slow axis of the ¼ wavelength plate forms 45° with respect to the polarization reflection axis of the linear polarization reflection plate. The ¼ wavelength plate and the linear polarization reflection plate may be adhered with, for example, an adhesive layer.

In a case where the half mirror is used for a mirror with an image display function, the linear polarization reflection plate is disposed and used so as to be a surface close to an image display device in the lamination-type circular polarization reflection layer. As a result, the light for image display from the image display device can be efficiently converted into circularly polarized light and emitted from the observation surface of the mirror with an image display function. In a case where the light for image display from the image display device is linearly polarized light, the polarization reflection axis of the linear polarization reflection plate may be adjusted so as to transmit the linearly polarized light.

The thickness of the circular polarization reflection layer including a linear polarization reflection plate and a ¼ wavelength plate is preferably in a range of 2.0 μm to 300 μm, and more preferably in a range of 8.0 μm to 200 μm.

As the linear polarization reflection plate, those described above as a linear polarization reflection layer can be used.

As the ¼ wavelength plate, a ¼ wavelength plate to be described later can be used.

[Cholesteric Circular Polarization Reflection Layer]

The cholesteric circular polarization reflection layer includes at least one cholesteric liquid crystal layer. The cholesteric liquid crystal layer included in the cholesteric circular polarization reflection layer may exhibit selective reflection in a visible light region.

The circular polarization reflection layer may include two or more cholesteric liquid crystal layers, and may further include other layers such as an alignment layer. The circular polarization reflection layer preferably consists only of a cholesteric liquid crystal layer. In a case where the circular polarization reflection layer includes a plurality of cholesteric liquid crystal layers, these are preferably in direct contact with an adjacent cholesteric liquid crystal layer. The circular polarization reflection layer preferably includes three or more cholesteric liquid crystal layers.

The thickness of the cholesteric circular polarization reflection layer is preferably in a range of 1.0 μm to 300 μm, more preferably in a range of 1.5 μm to 100 μm, and even more preferably in a range of 2.0 μm to 20 μm.

In this specification, the cholesteric liquid crystal layer means a layer in which a cholesteric liquid crystalline phase is fixed. The cholesteric liquid crystal layer may be simply referred to as a liquid crystal layer.

The cholesteric liquid crystalline phase has been known to exhibit circularly polarized light selective reflection in which circularly polarized light of any one sense of either right-circularly polarized light or left-circularly polarized light is selectively reflected and circularly polarized light of the other sense is selectively transmitted in a specific wavelength region. In this specification, the circularly polarized light selective reflection may be simply referred to as selective reflection.

As a film including a layer in which a cholesteric liquid crystalline phase exhibiting circularly polarized light selective reflection is fixed, many films formed from a composition containing a polymerizable liquid crystal compound have been known, and regarding the cholesteric liquid crystal layer, the related arts can be referred to.

The cholesteric liquid crystal layer may be a layer in which alignment of a liquid crystal compound in a cholesteric liquid crystalline phase is held. Typically, the cholesteric liquid crystal layer may be a layer obtained in such a manner that a polymerizable liquid crystal compound is allowed to be in an alignment state of a cholesteric liquid crystalline phase, and polymerized and cured by ultraviolet irradiation, heating, and the like to form a layer having no fluidity, and at the same time, the layer is changed such that the form of alignment is not changed by an external field or an external force. In the cholesteric liquid crystal layer, the optical properties of the cholesteric liquid crystalline phase just need to be held in the layer, and the liquid crystal compound in the layer may not exhibit liquid crystallinity. For example, the molecular weight of the polymerizable liquid crystal compound may be increased by a curing reaction, and the liquid crystallinity may be lost.

A central wavelength λ of selective reflection of the cholesteric liquid crystal layer depends on a pitch P (periodicity of helix) of a helical structure in a cholesteric liquid crystalline phase, and has a relationship of λ=n×P with an average refractive index n of the cholesteric liquid crystal layer. The central wavelength of selective reflection of the cholesteric liquid crystal layer and the half-width can be obtained as follows.

A reducing peak of the transmittance is shown in a selective reflection region in a case where the transmission spectrum of a light reflecting layer (measured in a normal direction of a cholesteric liquid crystal layer) is measured using a spectrophotometer UV3150 (Shimadzu Corporation). In two wavelengths corresponding to transmittances at half of the highest peak height, in a case where the value of the short-wavelength side wavelength is represented by λ₁ (nm) and the value of the long-wavelength side wavelength is represented by λₕ (nm), the central wavelength of selective reflection and the half-width can be expressed by the following formulae.

Central Wavelength of Selective Reflection=(λ₁+λₕ)/2

Half-Width=(λₕ−λ₁)

The central wavelength λ of selective reflection of the cholesteric liquid crystal layer, obtained as described above, generally coincides with a wavelength at a centroid position of a reflection peak of a circular polarization reflection spectrum measured in the normal direction of the cholesteric liquid crystal layer. In this specification, the central wavelength of selective reflection means a central wavelength when measured in the normal direction of the cholesteric liquid crystal layer.

As is obvious from the above formula, the central wavelength of selective reflection can be adjusted by adjusting the pitch of the helical structure. By adjusting the n value and the P value, any one of right-circularly polarized light or left-circularly polarized light is selectively reflected with respect to light with a desired wavelength, and thus the central wavelength λ can be adjusted.

In a case where light is obliquely incident on the cholesteric liquid crystal layer, the central wavelength of selective reflection shifts to the short-wavelength side. Therefore, with respect to the wavelength of selective reflection necessary for image display, n×P is preferably adjusted such that λ calculated in accordance with the above formula λ=n×P becomes a long wavelength. In a case where the central wavelength of selective reflection when light rays pass through a cholesteric liquid crystal layer with a refractive index n₂ in a normal direction of the cholesteric liquid crystal layer (a helical axis direction of the cholesteric liquid crystal layer) at an angle of θ₂ is represented by λ_{d}, λ_{d} is expressed by the following formula.

λ_{d}=n₂×P×cos θ₂

In a case where the half mirror according to the embodiment of the invention is used for a mirror with an image display function, the reduction in the visibility of images in an oblique direction can be prevented by designing the central wavelength of selective reflection of the cholesteric liquid crystal layer included in the circular polarization reflection layer by taking the above description into consideration. In addition, the visibility of images in an oblique direction can be intentionally reduced. In addition, in the half mirror according to the embodiment of the invention or in a mirror with an image display function including the half mirror according to the embodiment of the invention, resulting from the above-described selective reflection properties, a tint may appear on images or mirror-reflected images viewed in an oblique direction. The tint can be prevented from appearing in a case where the circular polarization reflection layer includes a cholesteric liquid crystal layer having a central wavelength of selective reflection in an infrared light region. In this case, the central wavelength of selective reflection of the infrared light region may be specifically 780 to 900 nm, and preferably 780 to 850 nm.

In a case where a cholesteric liquid crystal layer having a central wavelength of selective reflection in an infrared light region is provided, it is preferably on the outermost side of all cholesteric liquid crystal layers having a central wavelength of selective reflection in a visible light region, and is more preferably on a layer farthest from the observation surface.

Since the pitch of the cholesteric liquid crystalline phase depends on the type or the concentration of a chiral agent which is used together with the polymerizable liquid crystal compound, a desired pitch can be obtained by adjusting the type or the concentration. Furthermore, methods described in “Introduction to Liquid Crystal Chemical Test”, p. 46, edited by Japan Liquid Crystal Society, published by Sigma Publications, 2007, and “Liquid Crystal Handbook”, p. 196, Liquid Crystal Handbook Editing Committee Maruzen can be used as a method of measuring the sense or the pitch of the helix.

In the half mirror, the circular polarization reflection layer preferably includes a cholesteric liquid crystal layer having a central wavelength of selective reflection in a red light wavelength region, a cholesteric liquid crystal layer having a central wavelength of selective reflection in a green light wavelength region, and a cholesteric liquid crystal layer having a central wavelength of selective reflection in a blue light wavelength region. The reflection layer preferably includes, for example, a cholesteric liquid crystal layer having a central wavelength of selective reflection in 400 nm to 500 nm, a cholesteric liquid crystal layer having a central wavelength of selective reflection in 500 nm to 580 nm, and a cholesteric liquid crystal layer having a central wavelength of selective reflection in 580 nm to 700 nm.

In a case where the circular polarization reflection layer includes a plurality of cholesteric liquid crystal layers, a cholesteric liquid crystal layer closer to the image display device preferably has a longer central wavelength of selective reflection. Due to such a configuration, a tint appearing in an oblique direction on an image can be suppressed.

Particularly, in a mirror with an image display function which uses a cholesteric circular polarization reflection layer including no ¼ wavelength plate, the central wavelength of selective reflection of each cholesteric liquid crystal layer is preferably different from the emission peak wavelength of the image display device by 5 nm or greater. This difference is more preferably 10 nm or greater. By shifting the central wavelength of selective reflection and the emission peak wavelength for image display of the image display device from each other, a display image can be made bright without reflection of light for image display by the cholesteric liquid crystal layer. The emission peak wavelength of the image display device can be confirmed in an emission spectrum during white display of the image display device. The peak wavelength may be a peak wavelength in a visible light region of the emission spectrum, and may be, for example, at least one selected from the group consisting of the emission peak wavelength λR of red light, the emission peak wavelength λG of green light, and the emission peak wavelength λB of blue light of the image display device which have been described above. The central wavelength of selective reflection of the cholesteric liquid crystal layer is preferably different from any of the emission peak wavelength λR of red light, the emission peak wavelength λG of green light, and the emission peak wavelength λB of blue light of the image display device which have been described above by 5 nm or greater, and more preferably by 10 nm or greater. In a case where the circular polarization reflection layer includes a plurality of cholesteric liquid crystal layers, the central wavelength of selective reflection of all of the cholesteric liquid crystal layers may be preferably different from the peak wavelength of the light emitted from the image display device by 5 nm or greater, and more preferably by 10 nm or greater. For example, in a case where the image display device is a full-color display device in which an emission peak wavelength λR of red light, an emission peak wavelength λG of green light, and an emission peak wavelength λB of blue light are shown in an emission spectrum during white display, the central wavelength of selective reflection of all of the cholesteric liquid crystal layers may be preferably different from any of λR, λG, and λB by 5 nm or greater, and more preferably by 10 nm or greater. In a case where the circular polarization reflection layer includes three cholesteric liquid crystal layers having different central wavelengths of selective reflection, that is, a cholesteric liquid crystal layer having a central wavelength of selective reflection represented by λ1, a cholesteric liquid crystal layer having a central wavelength of selective reflection represented by λ2, and a cholesteric liquid crystal layer having a central wavelength of selective reflection represented by λ3, a relationship of λB<λ1<λG<λ2<λR<λ3 is preferably satisfied.

In a case where the half mirror is used for a mirror with an image display function, a bright image can be displayed with high light utilization efficiency by adjusting the central wavelength of selective reflection of the cholesteric liquid crystal layer to be used according to the light emitting wavelength region of an image display device and the use mode of the circular polarization reflection layer. Examples of the use mode of the circular polarization reflection layer include an incidence angle of light on the circular polarization reflection layer and an image observation direction.

As each cholesteric liquid crystal layer, a cholesteric liquid crystal layer in which the sense of the helix is right-handed or left-handed is used. The sense of the reflected circularly polarized light of the cholesteric liquid crystal layer is identical to the sense of the helix. In a case where a plurality of cholesteric liquid crystal layers are included, the senses of the helices thereof may be the same as or different from each other. That is, cholesteric liquid crystal layers in which the helical sense is either right-handed or left-handed may be included, or cholesteric liquid crystal layers in which the helical sense is right-handed and cholesteric liquid crystal layers in which the helical sense is left-handed may be included. However, in a mirror with an image display function including a ¼ wavelength plate, a plurality of cholesteric liquid crystal layers preferably have the same sense of the helix. In that case, as for each cholesteric liquid crystal layer, the sense of the helix may be determined in accordance with the sense of circularly polarized light of a sense obtained by emission from the image display device and transmission through the ¼ wavelength plate. Specifically, a cholesteric liquid crystal layer having a sense of a helix which transmits circularly polarized light of a sense obtained by emission from the image display device and transmission through the ¼ wavelength plate may be used.

A half-width Δλ, (nm) of a selective reflection band in which selective reflection is exhibited depends on the birefringence Δn of the liquid crystal compound and the pitch P, and has a relationship of Δλ=Δn×P therewith. Therefore, the width of the selective reflection band can be controlled by adjusting Δn. Δn can be adjusted by adjusting the type or the mixing ratio of the polymerizable liquid crystal compound or controlling the temperature at the time of alignment fixing.

In order to form one type of cholesteric liquid crystal layers having the same central wavelength of selective reflection, a plurality of cholesteric liquid crystal layers having the same pitch P and the same sense of the helix may be laminated. By laminating cholesteric liquid crystal layers having the same pitch P and the same sense of the helix, circular polarization selectivity can be increased at a specific wavelength.

<¼ Wavelength Plate>

In a case where the half mirror is used for a mirror with an image display function, it is preferable that the half mirror further include a ¼ wavelength plate, and the molded resin layer, the polarization reflection plate (preferably circular polarization reflection plate layer, and more preferably cholesteric circular polarization reflection plate layer), and the ¼ wavelength plate be included in this order. The polarization reflection plate and the ¼ wavelength plate are preferably in direct contact with each other. Furthermore, the ¼ wavelength plate is preferably disposed between the image display device and the cholesteric circular polarization reflection layer. In a case where the ¼ wavelength plate is included between the image display device and the cholesteric circular polarization reflection layer, particularly, the light from the image display device which displays an image with linearly polarized light can be converted into circularly polarized light and made incident on the cholesteric circular polarization reflection layer. Therefore, the light reflected by the circular polarization reflection layer and returning to the image display device side can be significantly reduced, and a bright image can be displayed. In addition, with the use of the ¼ wavelength plate, a configuration can be made in which circularly polarized light of a sense that is reflected to the image display device side is not generated in the cholesteric circular polarization reflection layer, and thus a reduction in the image display quality based on multiple reflections between the image display device and the half mirror hardly occurs.

That is, for example, even in a case where the central wavelength of selective reflection of the cholesteric liquid crystal layer included in the cholesteric circular polarization reflection layer is substantially the same as the emission peak wavelength of blue light in an emission spectrum during white display of the image display device (the difference therebetween is, for example, less than 5 nm), the light emitted from the image display device can be transmitted to the observation surface side without generation of circularly polarized light of a sense that is reflected to the image display side in the circular polarization reflection layer.

In a case where the ¼ wavelength plate which is used in combination with the cholesteric circular polarization reflection layer is adhered to the image display device, the angle of the ¼ wavelength plate is preferably adjusted such that the image is made brightest. That is, particularly, regarding an image display device which displays an image with linearly polarized light, the relationship between the polarization direction (transmission axis) of the linearly polarized light and the slow axis of the ¼ wavelength plate is preferably adjusted such that the linearly polarized light is transmitted most efficiently. For example, in a case of a single layer-type ¼ wavelength plate, the transmission axis and the slow axis preferably form an angle of 45°. The light emitted from the image display device which displays an image with linearly polarized light is transmitted through the ¼ wavelength plate, and then becomes circularly polarized light of any one of right sense or left sense. The circular polarization reflection layer may be composed of a cholesteric liquid crystal layer having a twisted direction in which the circularly polarized light of the above-described sense is transmitted.

The ¼ wavelength plate may be a retardation layer which functions as a ¼ wavelength plate in a visible light region. Examples of the ¼ wavelength plate include a single layer-type ¼ wavelength plate and a broadband ¼ wavelength plate in which a ¼ wavelength plate and a ½ wavelength plate are laminated.

The front phase difference of the former ¼ wavelength plate may be ¼ of the light emission wavelength of the image display device. Therefore, as the ¼ wavelength plate, a retardation layer which exhibits inverse dispersibility such that for example, in a case where the light emission wavelength of the image display device is 450 nm, 530 nm, or 640 nm, the front phase difference is preferably 112.5 nm±10 nm, more preferably 112.5 nm±5 nm, and even more preferably 112.5 nm with a wavelength of 450 nm, the front phase difference is preferably 132.5 nm±10 nm, more preferably 132.5 nm±5 nm, and even more preferably 132.5 nm with a wavelength of 530 nm, and the front phase difference is preferably 160 nm±10 nm, more preferably 160 nm±5 nm, and even more preferably 160 nm with a wavelength of 640 nm is most preferable. However, a retardation plate which exhibits small wavelength dispersibility of phase difference or a retardation plate which exhibits forward dispersibility can also be used. The inverse dispersibility means a property that as the longer the wavelength, the larger the absolute value of the phase difference. The forward dispersibility means a property that as the shorter the wavelength, the larger the absolute value of the phase difference.

In the lamination-type ¼ wavelength plate, the ¼ wavelength plate and the ½ wavelength plate are bonded such that an angle of a slow axis thereof is 60°, and thus the ½ wavelength plate side is disposed on the side on which linearly polarized light is incident, and the slow axis of the ½ wavelength plate intersects with the polarization surface of the incident linearly polarized light by 15° or 75°. Since the lamination-type ¼ wavelength plate exhibits good inverse dispersibility of phase difference, it can be suitably used.

The ¼ wavelength plate is not particularly limited, and can be appropriately selected in accordance with the purpose. Examples thereof include a quartz plate, a stretched polycarbonate film, a stretched norbornene-based polymer film, a transparent film containing aligned inorganic particles exhibiting birefringence such as strontium carbonate, and a thin film in which an inorganic dielectric material is obliquely vapor-deposited on a support.

Examples of the ¼ wavelength plate include (1) retardation plate described in JP1993-027118A (JP-H5-027118A) and JP1993-027119A (JP-H5-027119A) in which a birefringent film having large retardation and a birefringent film having small retardation are laminated such that optical axes thereof are perpendicular to each other, (2) retardation plate described in JP1998-068816A (JP-H10-068816A) in which a polymer film having a ¼ wavelength at a specific wavelength and a polymer film made of the same material as the former polymer film and having a ½ wavelength at the same wavelength are laminated to obtain a ¼ wavelength in a wide wavelength region, (3) retardation plate described in JP1998-090521 (JP-H10-090521), capable of achieving a ¼ wavelength in a wide wavelength region by laminating two polymer films, (4) retardation plate capable of achieving a ¼ wavelength in a wide wavelength region by using a modified polycarbonate film described in WO00/26705A, and (5) retardation plate capable of achieving a ¼ wavelength in a wide wavelength region by using a cellulose acetate film described in WO00/65384A.

A commercially available product can also be used as the ¼ wavelength plate. Examples of the commercially available product include PURE-ACE (registered trademark) WR (polycarbonate film manufactured by TEIJIN LIMITED).

The ¼ wavelength plate may be formed by arranging and fixing a polymerizable liquid crystal compound and a polymer liquid crystal compound. For example, the ¼ wavelength plate can be formed by coating a surface of a temporary support or an alignment film with a liquid crystal composition, forming the polymerizable liquid crystal compound in the liquid crystal composition in a nematic alignment in a liquid crystal state, and then fixing the alignment by photo-crosslinking or thermal crosslinking. Details of the liquid crystal composition or the producing method thereof will be described later. The ¼ wavelength plate may be a layer which is obtained by coating a surface of a temporary support, a support, or an alignment film with a liquid crystal composition containing a polymer liquid crystal compound, forming the compound in a nematic alignment in a liquid crystal state, and then fixing the alignment by cooling.

The ¼ wavelength plate and the cholesteric circular polarization reflection layer may be adhered with an adhesive layer or in direct contact with each other, and are preferably in direct contact with each other.

<Method of Producing Cholesteric Liquid Crystal Layer and ¼ Wavelength Plate Formed from Liquid Crystal Composition>

Hereinafter, materials and methods for producing the cholesteric liquid crystal layer and the ¼ wavelength plate formed from a liquid crystal composition will be described.

Examples of the material used to form the ¼ wavelength plate include a liquid crystal composition containing a polymerizable liquid crystal compound. Examples of the material used to form the cholesteric liquid crystal layer include a liquid crystal composition further containing a chiral agent (optically active compound). The liquid crystal composition which is further mixed with a surfactant, a polymerization initiator, or the like if necessary and dissolved in a solvent or the like is coated on a temporary support, a support, an alignment film, a cholesteric liquid crystal layer serving as an underlayer, a ¼ wavelength plate, or the like, and after alignment and maturing, the liquid crystal composition is cured for fixing to form the cholesteric liquid crystal layer or the ¼ wavelength plate.

[Polymerizable Liquid Crystal Compound]

A rod-like liquid crystal compound may be used as the polymerizable liquid crystal compound.

Examples of the rod-like polymerizable liquid crystal compound include a rod-like nematic liquid crystal compound. As the rod-like nematic liquid crystal compound, azomethines, azoxys, cyanobiphenyls, cyanophenyl esters, benzoic acid esters, cyclohexanecarboxylic acid phenyl esters, cyanophenylcyclohexanes, cyano-substituted phenylpyrimidines, alkoxy-substituted phenylpyrimidines, phenyl dioxanes, tolans, and alkenylcyclohexyl benzonitriles are preferably used. It is possible to use not only a low-molecular liquid crystal compound, but also a polymer liquid crystal compound.

The polymerizable liquid crystal compound is obtained by introducing a polymerizable group in a liquid crystal compound. Examples of the polymerizable group include an unsaturated polymerizable group, an epoxy group, and an aziridinyl group. An unsaturated polymerizable group is preferable, and an ethylenically unsaturated polymerizable group is particularly preferable. The polymerizable group can be introduced in molecules of a liquid crystal compound by various methods. The number of the polymerizable groups in the polymerizable liquid crystal compound is preferably 1 to 6, and more preferably 1 to 3. Examples of the polymerizable liquid crystal compound include those described in Macromol. Chem., vol. 190, p. 2255 (1989), Advanced Materials, vol. 5, p. 107 (1993), U.S. Pat. No. 4,683,327A, U.S. Pat. No. 5,622,648A, U.S. Pat. No. 5,770,107A, WO95/22586A, WO95/24455A, WO97/00600A, WO98/23580A, WO98/52905A, JP1989-272551A (JP-H1-272551A), JP1994-16616A (JP-H6-16616A), JP1995-110469A (JP-H7-110469A), JP1999-80081A (JP-H11-80081A), and JP2001-328973A. Two or more types of polymerizable liquid crystal compounds may be used in combination. Using two or more types of polymerizable liquid crystal compounds in combination may contribute to lowering the alignment temperature.

The amount of the polymerizable liquid crystal compound added in the liquid crystal composition is preferably 80 mass % to 99.9 mass %, more preferably 85 mass % to 99.5 mass %, and particularly preferably 90 mass % to 99 mass % with respect to the solid content mass of the liquid crystal composition (mass excluding the mass of the solvent).

[Chiral Agent: Optically Active Compound]

The liquid crystal composition used to form the cholesteric liquid crystal layer preferably contains a chiral agent. The chiral agent functions to induce the helical structure of the cholesteric liquid crystalline phase. The chiral compound may be selected in accordance with the purpose since compounds are different in the helix pitch or the sense of the helix to be induced.

The chiral agent is not particularly limited, and a known compound can be used. Examples of the chiral agent include compounds described in Liquid Crystal Device Handbook (Third Chapter, Section 4-3, Chiral Agent for TN or STN, p. 199, edited by No. 142 Committee of Japan Society for the Promotion of Science, in 1989), JP2003-287623A, JP2002-302487A, JP2002-080478A, JP2002-080851A, JP2010-181852A, or JP2014-034581A.

In general, the chiral agent contains asymmetric carbon atoms. However, an axial asymmetric compound or a planar asymmetric compound containing no asymmetric carbon atoms can also be used as a chiral agent. Examples of the axial asymmetric compound or the planar asymmetric compound include binaphthyl, helicene, paracyclophane, and their derivatives. The chiral agent may have a polymerizable group. In a case where all of the chiral agent and the liquid crystal compound have a polymerizable group, the polymerization reaction of the polymerizable chiral agent and the polymerizable liquid crystal compound can give a polymer having a repeating unit derived from the polymerizable liquid crystal compound and a repeating unit derived from the chiral agent. In this embodiment, the polymerizable group of the polymerizable chiral agent is preferably the same type as the polymerizable group of the polymerizable liquid crystal compound. Accordingly, the polymerizable group of the chiral agent is also preferably an unsaturated polymerizable group, an epoxy group, or an aziridinyl group, more preferably an unsaturated polymerizable group, and particularly preferably an ethylenically unsaturated polymerizable group.

The chiral agent may be a liquid crystal compound.

As the chiral agent, an isosorbide derivative, an isomannide derivative, or a binaphthyl derivative can be preferably used. As the isosorbide derivative, a commercially available product such as LC-756 manufactured by BASF SE may be used.

The content of the chiral agent in the liquid crystal composition is preferably 0.01 mol % to 200 mol %, and more preferably 1.0 mol % to 30 mol % with respect to the total molar amount of the polymerizable liquid crystal compound.

[Polymerization Initiator]

The liquid crystal composition preferably contains a polymerization initiator. In an embodiment in which a polymerization reaction is carried out by ultraviolet irradiation, a polymerization initiator to be used is preferably a photopolymerization initiator capable of initiating a polymerization reaction by ultraviolet irradiation, and particularly preferably a radical photopolymerization initiator. Examples of the radical photopolymerization initiator include α-carbonyl compounds (described in U52367661A and U52367670A), acyloin ethers (described in U.S. Pat. No. 2,448,828A), α-hydrocarbon-substituted aromatic acyloin compounds (described in U.S. Pat. No. 2,722,512A), polynuclear quinone compounds (described in U.S. Pat. No. 3,046,127A and U52951758A), combination of triarylimidazole dimer and p-aminophenyl ketone (described in U53549367A), acridine and phenazine compounds (described in JP1985-105667A (JP-560-105667A) and U54239850A), acylphosphine oxide compounds (described in JP1988-040799B (JP-563-040799B), JP1993-029234B (JP-H5-029234B), JP1998-095788A (JP-H10-095788A), and JP1998-029997A (JP-H10-029997A)), oxime compounds (described in JP1988-040799B (JP-563-040799B), JP1993-029234B (JP-H5-029234B), JP1998-095788A (JP-H10-095788A), JP1998-029997A (JP-H10-029997A), JP2001-233842A, JP2000-080068A, JP2006-342166A, JP2013-114249A, JP2014-137466A, JP4223071B, JP2010-262028A, and JP2014-500852A), and oxadiazole compounds (described in U54212970A). For example, the description of paragraphs 0500 to 0547 in JP2012-208494A can also be referred to.

As the polymerization initiator, an acylphosphine oxide compound or an oxime compound is also preferably used.

As the acylphosphine oxide compound, for example, a commercially available product IRGACURE 819 (compound name: bis(2,4,6-trimethylbenzoyl)-phenylphosphine oxide) manufactured by BASF JAPAN can be used. As the oxime compound, a commercially available product IRGACURE OXE01 (manufactured by BASF SE), IRGACURE OXE02 (manufactured by BASF SE), TR-PBG-304 (manufactured by Changzhou Tronly New Electronic Materials Co., Ltd.), ADEKA ARKLS NCI-930 (manufactured by ADEKA CORPORATION), or ADEKA ARKLS NCI-831 (manufactured by ADEKA CORPORATION) can be used.

The polymerization initiators may be used alone or in combination of two or more types thereof.

The content of the polymerization initiator in the liquid crystal composition is preferably 0.1 to 20 mass %, and more preferably 0.5 mass % to 5.0 mass % with respect to the content of the polymerizable liquid crystal compound.

[Crosslinking Agent]

The liquid crystal composition may contain an arbitrary crosslinking agent in order to improve the film hardness after curing and durability. As the crosslinking agent, a material which is curable with ultraviolet rays, heat, moisture, or the like can be suitably used.

The crosslinking agent is not particularly limited, and can be appropriately selected in accordance with the purpose. Examples thereof include polyfunctional acrylate compounds such as trimethylolpropane tri(meth)acrylate and pentaerythritol tri(meth)acrylate; epoxy compounds such as glycidyl(meth)acrylate and ethylene glycol diglycidyl ether; aziridine compounds such as 2,2-bishydroxymethylbutanol-tris[3-(1-aziridinyl)propionate] and 4,4-bis(ethyleneiminocarbonylamino)diphenylmethane; isocyanate compounds such as hexamethylene diisocyanate and biuret-type isocyanate; polyoxazoline compounds having an oxazoline group in a side chain; and alkoxysilane compounds such as vinyltrimethoxysilane and N-(2-aminoethyl) 3-aminopropyltrimethoxysilane. A known catalyst can be used depending on the reactivity of the crosslinking agent in order to enhance productivity in addition to the enhancement of the film hardness and the durability. These may be used alone or in combination of two or more types thereof.

The content of the crosslinking agent in the liquid crystal composition is preferably 3.0 mass % to 20 mass %, and more preferably 5.0 mass % to 15 mass %. In a case where the content of the crosslinking agent is 3.0 mass % or greater, the crosslinking density improving effect can be obtained. In addition, in a case where the content of the crosslinking agent is 20 mass % or less, the stability of a layer to be formed can be maintained.

[Alignment Control Agent]

In the liquid crystal composition, an alignment control agent may be added to contribute to stable or rapid planar alignment. Examples of the alignment control agent include fluorine (meth)acrylate-based polymers described in paragraphs 0018 to 0043 in JP2007-272185A and compounds represented by Formulae (I) to (IV) described in paragraphs 0031 to 0034 in JP2012-203237A.

The alignment control agents may be used alone or in combination of two or more types thereof.

The amount of the alignment control agent added in the liquid crystal composition is preferably 0.01 mass % to 10 mass %, more preferably 0.01 mass % to 5.0 mass %, and particularly preferably 0.02 mass % to 1.0 mass % with respect to the total mass of the polymerizable liquid crystal compound.

[Other Additives]

The liquid crystal composition may contain at least one selected from various additives such as a surfactant for uniformizing the thickness by adjusting the surface tension of the coating film and a polymerizable monomer. Furthermore, if necessary, within a range that does not deteriorate the optical performance, a polymerization inhibitor, an antioxidant, an ultraviolet absorber, a light stabilizer, a coloring material, metal oxide particles, and the like can be added to the liquid crystal composition.

[Solvent]

The solvent used to prepare the liquid crystal composition is not particularly limited, and can be appropriately selected in accordance with the purpose. An organic solvent is preferably used.

The organic solvent is not particularly limited, and can be appropriately selected in accordance with the purpose. Examples thereof include ketones, alkyl halides, amides, sulfoxides, heterocyclic compounds, hydrocarbons, esters, and ethers. These may be used alone or in combination of two or more types thereof. Among these, ketones are particularly preferable in consideration of the load imposed on the environment.

[Coating, Alignment, and Polymerization]

The method of coating a temporary support, an alignment film, a ¼ wavelength plate, a cholesteric liquid crystal layer serving as an underlayer, or the like with a liquid crystal composition is not particularly limited, and can be appropriately selected in accordance with the purpose. Examples of the coating method when coating other than the coating with a liquid crystal composition is mentioned in this specification include a wire bar coating method, a curtain coating method, an extrusion coating method, a direct gravure coating method, a reverse gravure coating method, a die-coating method, a spin coating method, a dip coating method, a spray coating method, and a slide coating method. Furthermore, the coating can also be performed by transferring a liquid crystal composition, which has been separately applied onto a support. By heating the liquid crystal composition applied, the liquid crystal compound is aligned. In the formation of the cholesteric liquid crystal layer, the liquid crystal compound is preferably aligned in a cholesteric manner, and in the formation of the ¼ wavelength plate, the liquid crystal compound is preferably aligned in a nematic manner. In the cholesteric alignment, the heating temperature is preferably equal to or lower than 200° C., and more preferably equal to or lower than 130° C. By this alignment, an optical thin film is obtained in which the polymerizable liquid crystal compound is aligned in a twisted manner to have a helical axis in a direction substantially perpendicular to the surface of the film. In the nematic alignment, the heating temperature is preferably 50° C. to 120° C., and more preferably 60° C. to 100° C.

The aligned liquid crystal compound can be further subjected to polymerization so as to cure the liquid crystal composition. The polymerization may be any one of thermal polymerization or photopolymerization using light irradiation, but is preferably photopolymerization. Ultraviolet rays are preferably used for light irradiation. The irradiation energy is preferably 20 mJ/cm² to 50 J/cm², and more preferably 100 mJ/cm² to 1,500 mJ/cm². In order to accelerate the photopolymerization reaction, the light irradiation may be performed under heating conditions or in a nitrogen atmosphere. The wavelength of the ultraviolet rays for irradiation is preferably 350 nm to 430 nm. From the viewpoint of stability, the rate of the polymerization reaction is preferably high. The rate of the polymerization reaction is more preferably equal to or higher than 70%, and even more preferably equal to or higher than 80%. The rate of the polymerization reaction can be determined by measuring the consumption rate of polymerizable groups by using an IR absorption spectrum.

The thickness of each cholesteric liquid crystal layer is not particularly limited as long as it is in such a range that the above-described characteristics are exhibited. The thickness is preferably in a range of 0.5 μm to 100 μm, and more preferably in a range of 1.0 μm to 40 μm. In addition, the thickness of the ¼ wavelength plate formed from the liquid crystal composition is not particularly limited, but may be preferably 0.2 μm to 10 μm, and more preferably 0.5 μm to 2.0 μm.

[Lamination Film of Layers Formed from Polymerizable Liquid Crystal Compound]

In the formation of a lamination film consisting of a plurality of cholesteric liquid crystal layers and a lamination film consisting of a ¼ wavelength plate and a plurality of cholesteric liquid crystal layers, a step of directly coating a surface of a ¼ wavelength plate or a front cholesteric liquid crystal layer with a liquid crystal composition containing a polymerizable liquid crystal compound and the like, an alignment step, and a fixing step may be repeated in each case. Otherwise, a ¼ wavelength plate, a cholesteric liquid crystal layer, or a laminate thereof prepared separately may be laminated using an adhesive or the like, and the former is preferable. The reason for this is that interference unevenness resulting from thickness unevenness of the adhesive layer is hardly observed. In addition, the reason for this is that in a lamination film of cholesteric liquid crystal layers, in a case where a cholesteric liquid crystal layer is formed so as to be in direct contact with a surface of a cholesteric liquid crystal layer formed previously, an alignment direction of liquid crystal molecules on the air interface side of the cholesteric liquid crystal layer formed previously is identical to an alignment direction of liquid crystal molecules on the lower side of the cholesteric liquid crystal layer formed thereon, and the polarization characteristics of the laminate of the cholesteric liquid crystal layers are enhanced.

[Temporary Support, Support, and Alignment Layer]

The liquid crystal composition is preferably coated on a surface of a support, a temporary support, or an alignment layer formed on the surface of the support or the temporary support to form a layer. The support may not be peeled off after the formation of the layer, and the temporary support, or the temporary support and the alignment layer may be peeled off after the formation of the layer.

Examples of the temporary support and the support include a plastic film and a glass plate. Examples of the material of the plastic film include polyester such as polyethylene terephthalate (PET), polycarbonate, an acrylic resin, an epoxy resin, polyurethane, polyamide, polyolefin, a cellulose derivative, and silicone. A temporary support which is a plastic film preferably functions as a base film of a transfer sheet to be described later. The temporary support may function as a protective film until the half mirror is used, for example, until the half mirror is adhered to the image display device.

The alignment layer can be provided by means of rubbing of an organic compound (resin such as polyimide, polyvinyl alcohol, polyester, polyarylate, polyamideimide, polyether imide, polyamide, and modified polyamide) such as a polymer, oblique vapor deposition of an inorganic compound, formation of a layer having microgrooves, or accumulation of an organic compound (for example, ω-tricosanoic acid, dioctadecylmethylammonium chloride, or methyl stearate) using a Langmuir-Blodgett method (LB method). Furthermore, an alignment layer may be used which obtains an orientation function by the application of an electric field or a magnetic field or by being irradiated with light.

Particularly, it is preferable that an alignment layer composed of a polymer be rubbed, and then the rubbed surface be coated with the liquid crystal composition. The rubbing can be performed by rubbing the surface of the polymer layer several times with paper or cloth in a certain direction.

The liquid crystal composition may be coated on a surface of a temporary support or a rubbed surface of a temporary support without providing the alignment layer.

The thickness of the alignment layer is preferably 0.01 μm to 5.0 μm, and more preferably 0.05 μm to 2.0 μm.

<High-Re Retardation Film>

The half mirror according to the embodiment of the invention includes a high-Re retardation film. In this specification, the “high-Re retardation film” means a retardation film having a high front phase difference, which is distinguished from the ¼ wavelength plate (retardation plate). At least one high-Re retardation film is included between the observation surface and the polarization reflection plate. The half mirror according to the embodiment of the invention preferably includes one or two high-Re retardation films.

The half mirror according to the embodiment of the invention includes a first high-Re retardation film as a high Re-retardation film between the observation surface and the molded resin layer. The half mirror according to the embodiment of the invention preferably includes only the first high-Re retardation film as a high-Re retardation film.

In a case where the half mirror according to the embodiment of the invention includes two or more high Re-retardation films, a second high-Re retardation film is preferably further included as a high-Re retardation film between the molded resin layer and the polarization reflection plate. That is, a high-Re retardation film is preferably disposed on both surfaces of the molded resin layer.

In this specification, in a case where a “high-Re retardation film” is simply described, it corresponds to any of the “first high-Re retardation film” and the “second high-Re retardation film”.

In a case where the half mirror according to the embodiment of the invention includes two or more high-Re retardation films, the two or more high Re retardation films preferably have the same slow axis direction. Specifically, in a case where the half mirror according to the embodiment of the invention includes a first high-Re retardation film and a second high-Re retardation film, the slow axis direction of the first high-Re retardation film and the slow axis direction of the second high-Re retardation film are preferably the same. By using the half mirror according to the embodiment of the invention in which the slow axis directions are the same, it is possible to provide an image display device in which image unevenness is more efficiently reduced.

The total front phase difference of the high-Re retardation films is preferably 3,000 nm or greater, and more preferably 5,000 nm or more. The total front phase difference of the high-Re retardation films is preferably as large as possible, but is preferably 100,000 nm or less, more preferably 50,000 nm or less, even more preferably 40,000 nm or less, and particularly preferably 30,000 nm or less in consideration of the manufacturing efficiency and the reduction in film thickness.

The first high-Re retardation film preferably has a front phase difference of 3,000 nm or greater.

In a case where the half mirror according to the embodiment of the invention includes two or more high-Re retardation films, the front phase difference of each high-Re retardation film is preferably 1,500 nm or greater, more preferably 2,000 nm or greater, and even more preferably 3,000 nm or greater. In addition, the two or more high-Re retardation films preferably have the same front phase difference since the manufacturing is facilitated. Particularly, in a case where the half mirror according to the embodiment of the invention includes a first high-Re retardation film and a second high-Re retardation film, the first high-Re retardation film and the second high-Re retardation film preferably have the same front phase difference.

As described above, the molded resin layer is likely to have non-uniform birefringence. In a case where the half mirror is used for a mirror with an image display function, the light for forming an image is transmitted through the molded resin layer. Accordingly, in a case where an image is observed through polarizing sunglasses, brightness unevenness or color unevenness occurs due to the influence of the above-described non-uniform birefringence. Similarly, since a mirror-reflected image is also observed with the light transmitted twice through the molded resin layer, brightness unevenness or color unevenness easily occurs due to the influence of the above-described non-uniform birefringence in a case where the image is observed through polarizing sunglasses.

In addition, a reinforced glass (for example, reinforced glass that does not have a laminated glass configuration) which is used as a window glass of a vehicle, particularly, a rear glass is known to have birefringent distribution. Therefore, a mirror-reflected image based on the light that passes through a rear glass of a vehicle and is then incident on a front surface of the mirror with an image display function is thought to have brightness unevenness or color unevenness. That is, it is thought that in a case where a polarization component associated with the distribution is generated in light that is incident on the front surface of the mirror with an image display function due to the birefringent distribution, a difference is generated in the intensity of reflected light due to the interference of the reflected light from the front surface (outermost surface) of the mirror with an image display function and the selectively reflected light from the circular polarization reflection layer, and causes the above-described brightness unevenness or color unevenness.

With the high-Re retardation film, polarized light can be changed into pseudo non-polarized light, and thus brightness unevenness or color unevenness can be eliminated.

The front phase difference enabling polarized light to be changed into pseudo non-polarized light is described in paragraphs 0022 to 0033 in JP2005-321544A. The specific numerical value of the front phase difference can be determined according to the molded resin layer, and in a vehicle mirror with an image display function to be described later, according to the molded resin layer and the vehicle.

A plastic film or a birefringent material such as a quartz plate can be used as the high-Re retardation film. Examples of the plastic film include a polyester film such as polyethylene terephthalate (PET), a polycarbonate film, a polyacetal film, and a polyarylate film. Regarding a retardation film including PET and having a high phase difference, JP2013-257579A, JP2015-102636A, and the like can be referred to. Commercially available products such as OPTICAL COSMOSHINE (registered trademark) of a super birefringence type (TOYOBO CO., LTD.) may be used.

In general, a plastic film having a high phase difference can be formed in such a manner that a resin is melted and extruded, and then cast on a drum or the like to be formed into a film shape, and the film is uniaxially or biaxially stretched at a stretching ratio of 2 to 5 while being heated. After the stretching, a heat treatment called “thermal fixing” may be performed at a temperature higher than the stretching temperature in order to promote crystallization and raise the hardness of the film.

A high Re-retardation film may be produced by laminating a plurality of films having a phase difference. Between the plurality of films having a phase difference, other layers such as an adhesive layer may be included.

The thickness of the high Re-retardation film is preferably 1.0 μm to 10,000 μm, more preferably 10 μm to 1,000 μm, and even more preferably 20 μm to 200 μm.

<Optical Functional Layer>

The half mirror according to the embodiment of the invention may include an optical functional layer. In the half mirror according to the embodiment of the invention, the optical functional layer is preferably provided such that the optical functional layer, the first high Re-retardation film, the molded resin layer, and the reflective polarizing plate are arranged in this order.

In the half mirror according to the embodiment of the invention, a layer which is transparent in a visible light region is used as the optical functional layer.

Examples of the optical functional layer include a hard coat layer, an antiglare layer, an antireflection layer, and an antistatic layer.

The optical functional layer is preferably a cured layer of a polymerizable composition provided on the first high-Re retardation film. It is preferable that after provision of the optical functional layer on the first high-Re retardation film, the optical functional layer integrated with the first high-Re retardation film be provided on the molded resin layer.

[Hard Coat Layer]

A hard coat layer may be included as an outermost layer of the half mirror, and other layers may be further provided outside the hard coat layer.

In this specification, the hard coat layer refers to a layer which is formed to increase the pencil hardness of the surface of the half mirror. Specifically, the hard coat layer is a layer whose pencil hardness (JIS K5400) is not less than H after the lamination of the hard coat layer. The pencil hardness after the lamination of the hard coat layer may be preferably 2H or greater, and more preferably 3H or greater. The thickness of the hard coat layer is preferably 0.1 μm to 100 μm, more preferably 1.0 μm to 70 μm, and even more preferably 2.0 μm to 50 μm.

The hard coat layer may also serve as an antireflection layer or an antistatic layer.

Specific examples of the hard coat layer include a layer formed from a composition containing an ultraviolet curable polymerizable compound. The composition may contain other components such as particles. (Meth)acrylate is preferable as the ultraviolet curable polymerizable compound. Regarding the material and the producing method for the hard coat layer, JP2016-071085A, JP2012-168295A, JP2011-225846A, and the like can be referred to.

[Antiglare Layer]

The antiglare layer is a layer for imparting antiglare properties based on surface scattering. The antiglare layer may be included as an outermost layer of the half mirror, and other layers may be further provided outside the antiglare layer.

The antiglare layer can be formed from a composition containing a binder resin forming compound for an antiglare layer and particles for an antiglare layer.

Regarding the material and the producing method for the antiglare layer, paragraphs 0101 to 0109 in JP2013-178584A, JP2016-053601A, and the like can be referred to.

[Antireflection Layer]

An antireflection layer is preferably included in the outermost surface of the half mirror. By providing the antireflection layer, light reflection by the outermost surface is suppressed, and thus a mirror-reflected image based on the image derived from the light from the polarization reflection plate can be clearly observed. Regarding the material and the producing method for the antireflection layer, paragraphs 0049 to 0053 in WO2015/050202A can be referred to.

[Antistatic Layer]

An antistatic layer is preferably included in the outermost surface of the half mirror. Regarding the material and the producing method for the antistatic layer, paragraphs 0020 to 0028 in JP2012-027191A can be referred to.

<Adhesive Layer>

The half mirror may include an adhesive layer for adhesion of each layer. The adhesive layer may be formed from an adhesive. An adhesive layer is preferably included between the molded resin layer and the polarization reflection plate. In addition, an adhesive layer is preferably included between the first high-Re retardation film and the molded resin layer. In addition, an adhesive layer is preferably included between the second high-Re retardation film and the molded resin layer.

Adhesives are classified into thermosetting types, photocurable types, reaction-curable types, and pressure-sensitive types which do not require curing from the viewpoint of curing method. As the materials of these adhesives, it is possible to use compounds based on acrylate, urethane, urethane acrylate, epoxy, epoxy acrylate, polyolefin, modified olefin, polypropylene, ethylene vinyl alcohol, vinyl chloride, chloroprene rubber, cyanoacrylate, polyamide, polyimide, polystyrene, polyvinyl butyral, or the like. From the viewpoint of workability and productivity, photocuring is preferable as the curing method. From the viewpoint of optical transparency and heat resistance, materials based on acrylate, urethane acrylate, epoxy acrylate, or the like are preferably used.

An adhesive layer of a pressure-sensitive type which does not require curing can be formed using a commercially available sheet-like adhesive layer. A so-called high-transparency adhesive transfer tape (OCA tape) may also be used. A commercially available product for an image display device, particularly, a commercially available product for a surface of an image display portion of an image display device may be used as the high-transparency adhesive transfer tape. Examples of the commercially available products include pressure-sensitive adhesive sheets (such as PD-S1) manufactured by PANAC Corporation and pressure-sensitive adhesive sheets of MHM series manufactured by NICHIEI KAKOH CO., LTD.

For example, the molded resin layer and the high Re-retardation film can be achieved with a pressure-sensitive type adhesive layer which does not require curing.

<Thermoplastic Welding Layer>

The half mirror may include a thermoplastic welding layer. The thermoplastic welding layer is used for adhesion between layers. The thermoplastic welding layer is melted by heating, and then cooled to adhere the layers. The thermoplastic welding layer is preferably used for adhesion between the molded resin layer and another layer, and the thermoplastic welding layer and the molded resin layer are preferably in direct contact with each other. Particularly, as will be described later, the thermoplastic welding layer is preferably used when the high-Re retardation film or polarization reflection plate is provided on any one surface of the molded resin layer simultaneously with the manufacturing of the molded resin layer by injection molding or the like. The molded resin layer and the thermoplastic welding layer may form a mixed layer in which components of both the layers are mixed. A mixed layer may be formed between the molded resin layer and the thermoplastic welding layer. A thermoplastic welding layer is preferably included between the molded resin layer and the polarization reflection plate. In addition, a thermoplastic welding layer is preferably included between the first high-Re retardation film and the molded resin layer. In addition, a thermoplastic welding layer is preferably included between the second high-Re retardation film and the molded resin layer.

The thermoplastic welding layer includes a thermoplastic resin. Examples of the thermoplastic resin include a vinyl chloride resin, a vinyl acetate resin, a copolymer resin of vinyl chloride and vinyl acetate, a copolymer resin of ethylene and vinyl acetate, a copolymer resin of isobutene and maleic anhydride, a(meth)acrylic resin, a (meth)acrylic copolymer resin, a copolymer resin of styrene and butadiene, a urethane resin, a polyester resin, an epoxy resin, a silicone resin, a modified silicone resin, a rosin resin, a polyvinyl acetal resin, chloroprene rubber, nitrile rubber, and a nitrile resin.

The thickness of the thermoplastic welding layer may be 0.1 μm to 100 μm, preferably 0.5 μm to 30 μm, and more preferably 1.0 μm to 8.0 μm. By adjusting the thickness of the thermoplastic welding layer to 1.0 μm or greater, sufficient adhesiveness to the substrate is secured. Further, by adjusting the thickness of the thermoplastic welding layer to 8.0 μm or less, the surface roughness is easily suppressed, and a mirror surface shape is easily obtained.

The thermoplastic welding layer can be formed by coating a surface of the polarization reflection layer, a release sheet, or the like with a coating liquid containing a thermoplastic resin. Examples of the solvent of the coating liquid include amides (for example, N,N-dimethylformamide), sulfoxides (for example, dimethylsulfoxide), heterocyclic compounds (for example, pyridine), hydrocarbons (for example, benzene, hexane, and cyclohexane), alkyl halides (for example, chloroform and dichloromethane), esters (for example, methyl acetate and butyl acetate), ketones (for example, acetone, methyl ethyl ketone, methyl isobutyl ketone, and cyclohexanone), ethers (for example, tetrahydrofuran, 1,2-dimethoxyethane), and alkyl alcohols (for example, methanol, ethanol, and propanol). Two or more types of solvents may be mixed and used. Among the above solvents, alkyl halides, esters, ketones, and mixed solvents thereof are preferable.

As the coating liquid for forming a thermoplastic welding layer, a commercially available composition as a heat sealing agent can be used as it is, or used by being dissolved in or diluted with a solvent.

<<Method of Manufacturing Half Mirror>>

The half mirror according to the embodiment of the invention may be manufactured by adhering the respective layers using an adhesive layer. Otherwise, the high-Re retardation film or polarization reflection plate may be provided on any one surface of the molded resin layer simultaneously with the manufacturing of the molded resin layer by injection molding or the like, and other layers may be adhered thereto using an adhesive layer to manufacture the half mirror.

A half mirror including only a first high-Re retardation film as a high-Re retardation film can be obtained by any of the following procedures.

A polarization reflection plate is adhered to one main surface side of a molded resin layer, and a first high-Re retardation film is adhered to the other main surface side by using an adhesive layer; simultaneously with the production of a molded resin layer, a polarization reflection plate is provided on one main surface side of the molded resin layer, and a first high-Re retardation film is adhered to the other main surface side by using an adhesive layer; simultaneously with the production of a molded resin layer, a first high-Re retardation film is provided on one main surface side of the molded resin layer, and a polarization reflection plate is adhered to the other main surface side by using an adhesive layer; simultaneously with the production of a molded resin layer, a polarization reflection plate is provided on one main surface side of the molded resin layer, and a first high-Re retardation film is provided on the other main surface side.

A half mirror including a first high-Re retardation film and a second high-Re retardation film as a high-Re retardation film can be obtained by any of the following procedures.

By using an adhesive layer, a first high-Re retardation film is adhered to one main surface side of a molded resin layer, and a second high-Re retardation film is adhered to the other main surface side, and further, by using an adhesive layer, a polarization reflection plate is adhered to a surface side of the second high-Re retardation film to which the molded resin layer is not adhered; simultaneously with the production of a molded resin layer, a second high-Re retardation film is provided on one main surface side of the molded resin layer, and a polarization reflection plate is adhered to the second high-Re retardation film side of the obtained molded body by using an adhesive layer. Then, a first high-Re retardation film is adhered to the other main surface side of the molded resin layer by using an adhesive layer; simultaneously with the production of a molded resin layer, a first high-Re retardation film is provided on one main surface side of the molded resin layer, a polarization reflection plate is adhered to the other main surface side, and a second high-Re retardation film is adhered by using an adhesive layer in this order; simultaneously with the production of a molded resin layer, a first high-Re retardation film is provided on one main surface side of the molded resin layer, a second high-Re retardation film is provided on the other main surface side, and then a polarization reflection plate is adhered to the second high-Re retardation film side of the obtained molded body by using an adhesive layer.

<Injection Molding>

The molded resin layer is preferably manufactured by injection molding. The injection molding is a method in which a resin is melted by heating, and then the molten resin is injected under pressure into a mold, and solidified or cured to obtain a molded product. The inside of the mold means the inside of the space formed by the mold. In general, a space may be formed by two molds composed of a male mold and a female mold.

In the injection of the molten resin into the mold under pressure, the injection speed is preferably 1 mm/sec to 50 mm/sec, and more preferably 5 mm/sec to 30 mm/sec.

The injection molding is performed by heating and pressing a molten resin in the mold and by then cooling the resin.

The heating temperature (mold temperature: temperature of the inner surface of the mold) may be 50° C. to 150° C., and preferably 80° C. to 130° C. By adjusting the heating temperature within a temperature range of 50° C. to 150° C., it is possible to suppress the occurrence of sink marks, burrs, flow marks, or the like in the injection of the molten resin into the mold under pressure, and thus a molded resin layer having stable dimensions can be obtained. The pressure may be 0.01 MPa to 1.0 MPa, preferably 0.05 MPa to 0.5 MPa, and more preferably 0.1 MPa to 0.3 MPa. The heating and pressing time is preferably 1 second to 300 seconds, and more preferably 10 seconds to 120 seconds.

Cooling is preferably performed at room temperature or lower. Specifically, the cooling may be performed at 10° C. to 30° C. Pressing is preferably performed before the cooling. The pressing state is preferably maintained during the cooling. In general, in a case where the mold temperature is raised, the time to cool down increases, and thus there is a problem in that the molding cycle becomes longer. Therefore, the inner surface of the mold is preferably cooled in a short time. The inner surface of the mold is preferably cooled at 1° C./s to 100° C./s in view of abrasion resistance of the molded resin layer. The cooling rate for the inner surface of the mold is more preferably 30° C./s to 90° C./s, and even more preferably 40° C./s to 80° C./s.

The injection molding can be performed using an injection molding machine. The injection molding machine may have an injection mechanism, a temperature control mechanism, a mold clamping mechanism, or the like in addition to a mold or a part where the mold is installed.

[Mold]

The mold is usually composed of a two-piece set, and the above-described space is formed by clamping the two pieces. Either one of them is a fixed platen, and the other is a movable platen. In addition, either one of them is a female mold, and the other is a male mold. The female mold may be a fixed platen, or the male mold may be a fixed platen. The female mold is preferably a fixed platen.

<In-Mold System or Insert Molding>

As a method of providing at least one of the polarization reflection plate, the first high-Re retardation film, or the second high-Re retardation film (hereinafter, may be referred to as “polarization reflection plate or high-Re retardation film”) simultaneously with the production of the molded resin layer, a method known as in-mold system or insert molding can be used. There is no particular limitation on determining which one is to be used. The polarization reflection plate is preferably provided by in-mold system, and the high-Re retardation film is preferably provided by insert molding.

In the in-mold system, in a case where injection molding is performed, a polarization reflection plate or high-Re retardation film, and a molding sheet including a base film are sandwiched between molds. For example, a molding sheet is sandwiched between two molds, and a polarization reflection plate or high-Re retardation film is adhered to a surface of an injection-molded product in the mold simultaneously with injection molding. In the injection molding, a molten resin may be injected into the mold, and the base film, the polarization reflection plate or high-Re retardation film, and the molten resin may be disposed in this order. In a case where a molding sheet having a thermoplastic welding layer is used, the base film, the polarization reflection plate or high-Re retardation film, the thermoplastic welding layer, and the molten resin are disposed in this order. Then, the base film is peeled off from the obtained molded body including the molded resin layer, the polarization reflection plate or high-Re retardation film, and the base film. In the in-mold system, a roll-like molding sheet can be fed into a mold, and a necessary portion of the roll-like molding sheet can be sequentially sandwiched between the molds to manufacture a half mirror.

In the insert molding, in a case where injection molding is performed, a molding sheet including a polarization reflection plate or high-Re retardation film is sandwiched between molds. For example, a molding sheet is sandwiched between two molds, and a polarization reflection plate or high-Re retardation film is adhered to a surface of an injection-molded product in the mold simultaneously with the injection molding. In a case where the molding sheet has a thermoplastic welding layer, the polarization reflection plate or high-Re retardation film, the thermoplastic welding layer, and the molten resin are disposed in this order. In the insert molding, the entire molding sheet substantially becomes a part of the finished product.

In a case where the molding sheet is sandwiched between molds, the molding sheet is preferably brought into contact with the inner surface of the mold. The contact between the molding sheet and the inner surface of the mold may be achieved in at least a part of the molding sheet, and is preferably achieved in a substantially entire surface of the area corresponding to the mold. That is, the entire corresponding area of the molding sheet is preferably closely adhered. The contact may be simply achieved by placing a transfer sheet on the mold, or means for achieving contact may be considered. Examples of the means for achieving contact include vacuum suction. Regarding vacuum suction, for example, JP1998-264201A (JP-H10-264201A) can be referred to.

In a case where other members are adhered after the molding of the molded resin layer, the molded body obtained by the injection molding may be removed from the mold, and then other members may be adhered thereto. In a case where the base film is peeled off from the molded body obtained by in-mold system, the base film may be peeled off before or after the adhesion of the optical functional layer.

[Molding Sheet]

The molding sheet preferably includes at least one of a polarization reflection plate, a first high-Re retardation film, or a second high-Re retardation film. The molding sheet may include a thermoplastic welding layer. Further, the molding sheet may include a base film.

When the molding sheet includes a thermoplastic welding layer, a resin mirror in which the polarization reflection plate or high-Re retardation film is integrated with the molded resin layer can be obtained by adhering the thermoplastic welding layer of the molding sheet to the molded resin layer (molten resin). The thermoplastic welding layer is preferably positioned on an outermost layer of the molding sheet.

For protection during conveyance or the like, a protective layer or the like may be provided on a surface of the outermost layer of the molding sheet, for example, a surface of the thermoplastic welding layer. The protective layer may be peeled off when the molding sheet is used.

(Transfer Sheet)

Particularly, a transfer sheet can be used as a molding sheet for providing a polarization reflection plate.

In injection molding of the molded resin layer, a transfer sheet can be used to provide a polarization reflection plate on the molded resin layer. The transfer sheet may have a plate shape or a film shape. The transfer sheet may have a roll shape.

The thickness of the transfer sheet may be 1.0 μm to 300 μm, and preferably 5.0 μm to 200 μm. The molding can be performed without the occurrence of wrinkles by adjusting the thickness of the transfer sheet to 1.0 μm to 300 μm.

The tensile elongation of the transfer sheet at room temperature is preferably 5% to 300%, more preferably 10% to 250%, and even more preferably 20% to 200%. The tensile elongation can be measured according to a tensile test for a thin plastic sheet (ASTMD 882).

The transfer sheet includes a polarization reflection plate. The transfer sheet preferably includes a thermoplastic welding layer. The transfer sheet may include other layers such as a base film, a release layer, an alignment layer, a protective layer, and an adhesive layer. The polarization reflection plate and the thermoplastic welding layer may be in direct contact with each other, or other layers may be provided therebetween.

As the transfer sheet, a polarization reflection plate produced as described above can be used as it is. Those having a temporary support during the production can use the temporary support as a base film as it is. A transfer sheet including a thermoplastic welding layer can be manufactured by forming the thermoplastic welding layer on a polarization reflection plate, usually on a surface of the polarization reflection plate. The thermoplastic welding layer can be produced by applying a coating liquid containing a thermoplastic resin to the polarization reflection plate and drying the coating liquid, or by transferring the thermoplastic welding layer from a release sheet on which the thermoplastic welding layer is formed to the polarization reflection plate.

(Base Film)

The molding sheet may include a base film. Particularly, the transfer sheet preferably includes a base film.

A material similar to a temporary support for forming a layer by applying a liquid crystal composition can be used as the base film. Preferable examples thereof include a polyethylene terephthalate film. A temporary support for forming a layer by applying a liquid crystal composition is preferably used as it is as the base film of the transfer sheet. The transfer sheet may include an alignment layer used during the formation of the polarization reflection plate, and in the method of manufacturing a half mirror, the alignment layer may be or may not be peeled off in a case where the base film is peeled off.

The thickness of the base film is usually about 5.0 to 200 μm, and preferably about 20 to 100 μm.

(Release Layer)

The molding sheet, particularly, the transfer sheet may include a release layer. The release layer is a layer which is provided on a surface of the base film and disposed between the base film and the polarization reflection plate or high-Re retardation film to facilitate separation between the base film and the polarization reflection plate or high-Re retardation film. In a case where the base film is peeled off, the release layer is peeled off together with the base film.

The release layer may cover the entire surface of the base film, or may be provided on a part of the base film. In general, the release layer preferably covers the entire surface of the base film in consideration of peelability.

The release layer can be formed using thermoplastic resins such as silicone resins, fluorine-based resins, acrylic resins (including, for example, acryl-melamine-based resins), polyester-based resins, polyolefin-based resins, polystyrene-based resins, polyurethane-based resins, cellulose-based resins, vinyl chloride-vinyl acetate-based copolymer resins, or nitrocellulose, copolymers of monomers which form the thermoplastic resins, or resins obtained by modifying the above resins with a (meth)acrylic acid or urethane alone, or using resin compositions obtained by mixing more than one of the above resins. Among these, acrylic resins, polyester-based resins, polyolefin-based resins, polystyrene-based resins, copolymers of monomers which form the resins, and resins obtained by modifying the above resins with urethane are preferable. More specific examples thereof include acryl-melamine-based resins, acryl-melamine-based resin-containing compositions, resin compositions obtained by mixing polyester-based resins and resins obtained by modifying copolymers of ethylene and acrylic acid with urethane, and resin compositions obtained by mixing acrylic resins and emulsions of copolymers of styrene and acryl. It is particularly preferable that the release layer be formed using an acryl-melamine-based resin alone, or using a composition containing 50 mass % or greater of an acryl-melamine-based resin. The thickness of the release layer may be about 0.01 to 5.0 μm, and preferably about 0.05 to 3.0 μm.

<<Usage of Half Mirror>>

The half mirror can be used for various purposes in accordance with optical characteristics of the polarization reflection plate. The half mirror is used for, for example, a vehicle (car-mounted) mirror, an optical lens, or an optical eyewear member. Among these, a vehicle mirror is preferable.

<<Mirror with Image Display Function>>

A mirror with an image display function can be produced using the half mirror according to the embodiment of the invention. The mirror with an image display function includes the half mirror and the image display device. In the mirror with an image display function, the observation surface, the molded resin layer, the polarization reflection plate, and the image display device are disposed in this order. In the mirror with an image display function, the image display device and the half mirror may be in direct contact with each other, or an air layer may be present therebetween. Otherwise, the image display device and the half mirror may be directly adhered to each other via an adhesive layer.

In the mirror with an image display function, a half mirror having the same surface area as the area of the image display portion of the image display device may be used, or a half mirror having a surface area larger or smaller than the area of the image display portion of the image display device may be used. By selecting these relationships, it is possible to adjust the ratio or position of the surface of the image display portion with respect to the entire surface of the mirror. In this specification, “surface area” refers to the area of either the front surface or the back surface of a plate-like or film-like member.

In a case where a half mirror including a ¼ wavelength plate is used, the slow axis of the ¼ wavelength plate is preferably adjusted such that the image is made brightest in the mirror with an image display function. That is, particularly, regarding an image display device which displays an image with linearly polarized light, the relationship between the polarization direction (transmission axis) of the linearly polarized light and the slow axis of the ¼ wavelength plate is preferably adjusted such that the linearly polarized light is transmitted most efficiently. For example, in a case of the ¼ wavelength plate, the transmission axis and the slow axis preferably form an angle of 45°. The light emitted from the image display device which displays an image with linearly polarized light is transmitted through the ¼ wavelength plate, and then becomes circularly polarized light of any one of right sense or left sense. The circular polarization reflection layer to be described later may be composed of a cholesteric liquid crystal layer having a twisted direction in which the circularly polarized light of the above-described sense is transmitted.

In a case where the ¼ wavelength plate is included between the image display device and the circular polarization reflection layer, the light from the image display device can be converted into circularly polarized light and made incident on the circular polarization reflection layer. Therefore, the light reflected by the circular polarization reflection layer and returning to the image display device side can be significantly reduced, and a bright image can be displayed.

<Image Display Device>

The image display device is preferably an image display device which emits linearly polarized light (emits light) to form an image. In a case where the half mirror according to the embodiment of the invention is disposed such that the slow axis of the high-Re retardation film and the polarization direction of the linearly polarized light emitted from the image display device form an angle of 30° to 60° to produce a mirror with an image display function, it is possible to observe an image having no brightness unevenness or color unevenness even through polarizing sunglasses.

The image display device may be a liquid crystal display device. In a case where the half mirror according to the embodiment of the invention is used in combination with an image display device having a backlight which provides a continuous emission spectrum as a backlight, brightness unevenness or color unevenness in the image observed through polarizing sunglasses can be eliminated. A white LED (white light emitting diode) is preferable as the backlight. Here, the continuous emission spectrum means, for example, an emission spectrum (for example, a spectrum of a visible light region of sunlight) of a visible light region where there is no wavelength region in which light emission is not substantially exhibited. Examples of the backlight which provides a continuous emission spectrum include a white LED, but do not include those exhibiting a discontinuous emission spectrum having a peak at a specific wavelength in a visible light wavelength region, such as a fluorescent lamp.

The liquid crystal display device may be a transmission type or a reflection type, and is particularly preferably a transmission type. The liquid crystal display device may be a liquid crystal display device of any one of an in plane switching (IPS) mode, a fringe field switching (FFS) mode, a vertical alignment (VA) mode, an electrically controlled birefringence (ECB) mode, a super twisted nematic (STN) mode, a twisted nematic (TN) mode, or an optically compensated bend (OCB) mode.

The image which is displayed on the image display portion of the image display device may be a still image, a motion picture, or simple texture information. The display may be monochrome display such as black and white display, multi-color display, or full-color display. Preferable examples of the image which is displayed on the image display portion of the image display device include an image taken by a car-mounted camera. This image is preferably a motion picture.

The image display device may exhibit, for example, an emission peak wavelength λR of red light, an emission peak wavelength λG of green light, and an emission peak wavelength λB of blue light in an emission spectrum during white display. By virtue of such emission peak wavelengths, full-color image display is possible. λR may be a wavelength in a range of 580 nm to 700 nm, and preferably 610 nm to 680 nm. λG may be a wavelength in a range of 500 nm to 580 nm, and preferably 510 nm to 550 nm. λB may be a wavelength in a range of 400 nm to 500 nm, and preferably 440 nm to 480 nm.

<<Method of Producing Mirror with Image Display Function>>

The mirror with an image display function can be produced by positioning the half mirror on the image display side of the image display device and integrating the image display device and the half mirror with each other. The half mirror is disposed such that the observation surface, the molded resin layer, the polarization reflection plate, and the image display device are arranged in this order. In addition, as described above, the half mirror is preferably disposed such that the slow axis of the first high-Re retardation film of the half mirror and the polarization direction of the linearly polarized light emitted from the image display device form an angle of 30° to 60°, and more preferably 40° to 50°. In this case, in a case where a half mirror including a first high-Re retardation film and a second high-Re retardation film is used, a half mirror in which the slow axis direction of the first high-Re retardation film and the slow axis direction of the second high-Re retardation film are the same is preferably used. In a case where the slow axis direction of the first high-Re retardation film and the slow axis direction of the second high-Re retardation film are the same, image unevenness can be efficiently reduced. For example, even in a case where each front phase difference is about 1,500 nm or greater and less than 3,000 nm, image unevenness can be reduced using a half mirror in which the slow axis directions of both high-Re retardation films are the same. In a case where the difference between the front phase difference of the first high-Re retardation film and the front phase difference of the second high-Re retardation film is 3,000 nm or greater, image unevenness can be reduced even in a case where the slow axis directions of both high-Re retardation films are different.

The integration of the image display device with the half mirror may be performed by connecting using a frame or a hinge, or adhesion. For example, a mirror with an image display function can be produced by adhering a half mirror to an image display surface of an image display device. The adhesion is performed such that the molded resin layer, the polarization reflection plate, and the image display device are arranged in this order. The adhesion between the image display device and the half mirror can be performed using the above-described adhesive layer, and a high-transparency adhesive transfer tape is preferably used.

<<Usage of Mirror with Image Display Function>>

The usage of the mirror with an image display function is not particularly limited. For example, the mirror with an image display function can be used as a mirror for security or a mirror for a beauty parlor or a barbershop to display an image such as texture information, a still image, and a motion picture. In addition, the mirror with an image display function may be used as a rearview mirror for a vehicle, or used for a personal computer, a smartphone, or a cell phone.

The mirror with an image display function is particularly preferably used as a rearview mirror for a vehicle. The mirror with an image display function may have a frame, a housing, a support arm for attachment to the vehicle body, or the like so as to be used as a rearview mirror. Alternatively, the vehicle mirror with an image display function may be formed for incorporation into a rearview mirror. In the vehicle mirror with an image display function having the above-described shape, it is possible to specify upward, downward, leftward, and rightward directions during normal use.

In a case where the mirror with an image display function is curved and the observation surface becomes a convex surface, the mirror can be made as a wide mirror enabling visual recognition of a rear visual field in a wide angle. Such a curved observation surface can be produced using a curved half mirror.

The curvature may be in a vertical direction, in a horizontal direction, or in vertical and horizontal directions. Regarding the curvature, the radius of curvature is preferably 500 mm to 3,000 mm, and more preferably 1,000 mm to 2,500 mm. The radius of curvature is a radius of a circumscribed circle of a curved portion, assumed in cross-section.

### EXAMPLES

Hereinafter, the invention will be described in more detail with reference to examples. The materials, the reagents, the amounts of materials, the proportions thereof, the operations, and the like which will be shown in the following examples can be appropriately modified within a range not departing from the gist of the invention. Accordingly, the scope of the invention is not limited to the following examples.

<Production of Half Mirror>

Half mirrors of Examples 1 to 20, Comparative Examples 1 to 4, and Reference Examples 1 to 4 were produced using the following materials and procedures shown in Table 3.

[Production of Polarization Reflection Plate]

(Preparation of Coating Liquid)

Coating liquids 1, 2, and 3 for forming a cholesteric liquid crystal layer and a coating liquid 4 for a ¼ wavelength plate were prepared with the following compositions shown in Table 1.

TABLE 1

| | | Coating Liquid 1 | Coating Liquid 2 | Coating Liquid 3 | Coating Liquid 4 |
|---|---|---|---|---|---|
| | Material | (central wavelength: | (central wavelength: | (central wavelength: | (¼ wavelength |
| Type | (manufacturer) | 630 nm) | 540 nm) | 450 nm) | layer) |
| Rod-Like Liquid | The Following | 100 parts by mass | 100 parts by mass | 100 parts by mass | 100 parts by mass |
| Crystal Compound | Compound 1 | | | | |
| Right-Twisting | PALIOCOLOR | 4.7 parts by mass | 5.5 parts by mass | 6.7 parts by mass | None |
| Chiral Agent | LC756 | | | | |
| | (BASF SE) | | | | |
| Polymerization | Irgacure 819 | 4 parts by mass | 4 parts by mass | 4 parts by mass | 4 parts by mass |
| Initiator | (BASF SE) | | | | |
| Alignment Control | The Following | 0.1 parts by mass | 0.1 parts by mass | 0.1 parts by mass | 0.1 parts by mass |
| Agent | Compound 2 | | | | |
| Solvent | 2-Butanone | 170 parts by mass | 170 parts by mass | 170 parts by mass | 170 parts by mass |
| | (Wako Pure | | | | |
| | Chemical Industries | | | | |
| | Ltd.) | | | | |

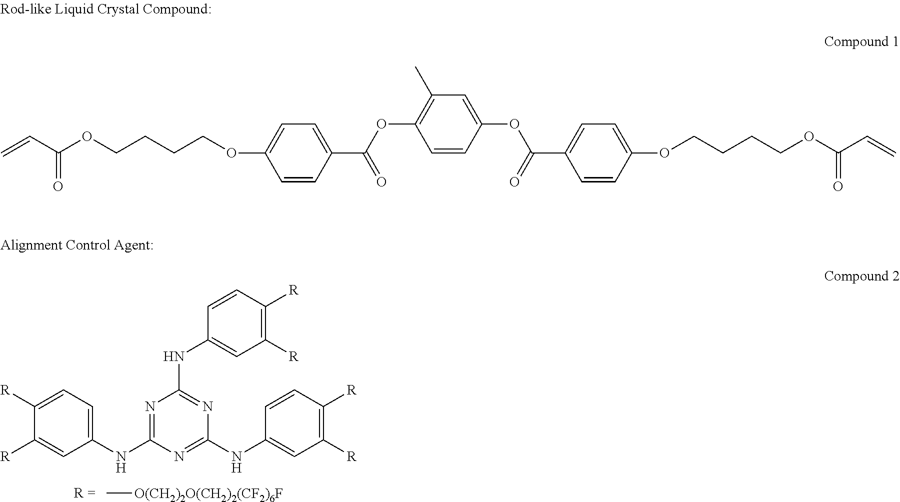

The compound 2 was manufactured using a method described in JP2005-099248A.

(Production of Circular Polarization Reflection Plate A)

A PET film (COSMOSHINE A4100, thickness: 100 μm) manufactured by TOYOBO CO., LTD. was used as a temporary support (100 mm×150 mm) and rubbed (rayon cloth, pressure: 0.1 kgf (0.98 N), rotation speed: 1,000 rpm, transport speed: 10 m/min, number of times: one reciprocation). The rubbed surface of the PET film was coated with the coating liquid 1 using a wire bar. After that, the film was dried, and then put on a hot plate at 30° C. The film was irradiated with UV light for 6 seconds by an electrodeless lamp “D-BULB” (60 mW/cm²) manufactured by HERAEUS to fix the cholesteric liquid crystalline phase, and thus a cholesteric liquid crystal layer having a thickness of 3.5 μm was obtained. The same steps were repeated on a surface of the obtained layer using the coating liquids 2 and 3, thereby obtaining a circular polarization reflection plate A having three cholesteric liquid crystal layers (layer of coating liquid 2: 3.0 μm, layer of coating liquid 3: 2.7 μm). The transmission spectrum of the circular polarization reflection plate A was measured using a spectrophotometer (manufactured by JASCO Corporation, V-670), and a transmission spectrum having a reflection peak at 630 nm, 540 nm, and 450 nm was obtained.

(Production of Circular Polarization Reflection Plate B (Including ¼ Wavelength Plate)

A rubbed surface of a PET film was coated with the coating liquid 4 using a wire bar. After that, the film was dried, and then put on a hot plate at 30° C. The film was irradiated with UV light for 6 seconds by an electrodeless lamp “D-BULB” (60 mW/cm²) manufactured by HERAEUS to fix the liquid crystalline phase, and thus a ¼ wavelength plate having a thickness of 0.8 μm was obtained. The same steps were repeated on a surface of the obtained layer using the coating liquids 1, 2, and 3, thereby obtaining a circular polarization reflection plate B having three cholesteric liquid crystal layers on the ¼ wavelength plate (layer of coating liquid 1: 3.5 μm, layer of coating liquid 2: 3.0 μm, layer of coating liquid 3: 2.7 μm). The transmission spectrum of the circular polarization reflection plate B was measured using V-670, and a transmission spectrum having a reflection peak at 630 nm, 540 nm, and 450 nm was obtained.

(Production of Linear Polarization Reflection Plate)

A linear polarization reflection plate was produced based on a method described in JP1997-506837A (JP-H9-506837A). 2,6-polyethylene naphthalate (PEN) and a copolyester (coPEN) of naphthalate (70) and terephthalate (30) were synthesized using an ethylene glycol as a diol in a standard polyester resin synthesis pot. A single layer film of PEN and coPEN was formed by extrusion molding, and then stretched at a stretching ratio of 5:1 at about 150° C. The refractive index of PEN associated with an alignment axis was confirmed to be about 1.88, the refractive index of PEN associated with a crossing axis was confirmed to be 1.64, and the refractive index of the coPEN film was confirmed to be about 1.64.

Next, coextrusion was performed using a 50-slot supply block in which a standard extrusion die was supplied, and thus alternate layers of PEN and coPEN, each having a thickness as shown in (1) of Table 2, were formed. By repeating the above procedures, layers of PEN and coPEN having a thickness shown in (2) to (5) of Table 2 were formed in order, and the formation of the layers of (1) to (5) was repeated 50 times to laminate total 250 layers. Then, the stretched films were thermally cured for 30 seconds at about 230° C. in an air oven to obtain a linear polarization reflection plate.

TABLE 2

| | (1) | (2) | (3) | (4) | (5) |
|---|---|---|---|---|---|
| PEN | 63.4 nm | 71.5 nm | 79.6 nm | 87.7 nm | 95.8 nm |
| coPEN | 68.5 nm | 77.2 nm | 86.0 nm | 94.7 nm | 103.5 nm |

[Production of ¼ Wavelength Plate with Temporary Support]

A rubbed surface of a PET film was coated with the coating liquid 4 using a wire bar. After that, the film was dried, and then put on a hot plate at 30° C. Next, the film was irradiated with UV light for 6 seconds by an electrodeless lamp “D-BULB” (60 mW/cm²) manufactured by HERAEUS to fix the liquid crystalline phase, and thus a ¼ wavelength plate with a temporary support having a thickness of 0.8 μm was obtained.

[Production of Light-Transmitting Base Material (High-Re Retardation Film)]

PET resin pellets having an intrinsic viscosity of 0.62 dl/g were dried under reduced pressure (1 Torr (133 Pa)) at 135° C. for 6 hours, and then supplied to an extruder and dissolved at 285° C. This polymer was filtered with a filtering medium formed of a stainless-steel sintered body (nominal filtration accuracy: 10 μm particle 95% cut), extruded in the form of a sheet from a mouthpiece, and then cooled and solidified by being wound on a casting drum having a surface temperature of 30° C. using an electrostatic casting method to prepare an unstretched film.

The unstretched film was guided to a tenter stretching machine. While an end portion of the film was gripped with a clip, the film was guided to a hot air zone at a temperature of 125° C., and stretched in a width direction. Next, while the width stretched in the width direction was maintained, the film was treated at a temperature of 225° C. for 30 seconds, and subjected to a 3% relaxation treatment in the width direction to obtain a uniaxially aligned light-transmitting base material having a front phase difference shown in Table 3. The front phase difference was measured using AxoScan manufactured by Axometrics, Inc.

[Production of Optical Functional Layer]

(Hard Coat Layer: HC)

DPHA (manufactured by Nippon Kayaku Co., Ltd.): 50 parts by mass

Irgacure 184 (manufactured by BASF JAPAN): 2.0 parts by mass

Methyl Ethyl Ketone: 50 parts by mass

A light-transmitting base material having a front phase difference of 8,000 nm was coated with the above coating liquid using a wire bar, and then dried and put on a hot plate at 30° C. Next, the film was irradiated with UV light for 6 seconds by an electrodeless lamp “D-BULB” (60 mW/cm²) manufactured by HERAEUS, and a hard coat layer having a thickness of 5.0 μm was formed.

(Antiglare Layer: AG)

DPHA (manufactured by Nippon Kayaku Co., Ltd.): 50 parts by mass

SX-350 (average particle diameter: 3.5 μm, refractive index: 1.55, manufactured by Soken Chemical & Engineering Co., Ltd., 30% toluene dispersion, used after dispersion by Polytron dispersing machine for 20 minutes at 10,000 rpm): 10 parts by mass

Irgacure 184 (manufactured by BASF JAPAN): 2.0 parts by mass

Toluene: 40 parts by mass

A light-transmitting base material having a front phase difference of 8,000 nm was coated with the above coating liquid using a wire bar, and then dried and put on a hot plate at 30° C. Next, the film was irradiated with UV light for 6 seconds by an electrodeless lamp “D-BULB” (60 mW/cm²) manufactured by HERAEUS, and an antiglare layer having a thickness of 5 μm was formed.

(Antireflection Layer: AR)

PETA (trade name: PET-30, manufactured by Nippon Kayaku Co., Ltd.): 50 parts by mass

KE-P30 (amorphous silica particles SEAHOSTAR manufactured by NIPPON SHOKUBAI CO., LTD., average primary particle diameter: 300 nm): 10 parts by mass

Irgacure 184 (manufactured by BASF JAPAN): 2.0 parts by mass

Butyl Acetate: 50 parts by mass

A light-transmitting base material having a front phase difference of 8,000 nm was coated with the above coating liquid using a wire bar, and then dried and put on a hot plate at 30° C. Next, the film was irradiated with UV light for 6 seconds by an electrodeless lamp “D-BULB” (60 mW/cm²) manufactured by HERAEUS, and an antireflection layer having a thickness of 5.0 μm was formed.

(Antistatic Layer: AS)

Ion-Conducting Compound (conductive polymer) IP-15 described in JP5674729B: 5 parts by mass

A-TMMT (Shin-Nakamura Chemical Co., Ltd.): 92 parts by mass

1-Butanol: 10 parts by mass

Methyl Ethyl Ketone: 90 parts by mass

A light-transmitting base material was coated with the above coating liquid using a wire bar, and then dried and put on a hot plate at 30° C. Next, the film was irradiated with UV light for 6 seconds by an electrodeless lamp “D-BULB” (60 mW/cm²) manufactured by HERAEUS to fix the cholesteric liquid crystalline phase, and an antistatic layer having a thickness of 5.0 μm was formed.

### <Production of Half Mirrors of Examples 1 to 6, 9, and 10, Comparative Examples 1 and 2, and Reference Examples 1 to 3> (Single in-Mold)

A surface of the cholesteric liquid crystal layer of the circular polarization reflection plate B was coated with a heat sealing agent A-100 (manufactured by DIC) using a wire bar, and then dried to form a thermoplastic welding layer of 3.0 μm, and a transfer sheet was obtained.

A mold composed of a combination of a concave mold and a convex mold was prepared as a mold for producing a flat plate. On the concave mold, a temporary support (base film) of the transfer sheet was disposed in such a direction as to be in contact with the inner surface of the mold, and the transfer sheet was brought into contact with the bottom surface of the concave portion by vacuum suction. The mold was closed by combining the concave mold with the convex mold, and in the formed space, a molten resin formed of PC (polycarbonate, IUPILON 53000) was injected into the mold so as to be in contact with a surface of the transfer sheet on the thermoplastic welding layer side, and molded (mold temperature: 90° C., resin temperature: 300° C., pressure: 100 MPa, time: 30 seconds). After cooling to room temperature, the mold was opened to take out the obtained molded body therefrom. The temporary support was peeled off, and the molded body was obtained. In the obtained molded body, the molded resin layer was a flat plate of 150 mm×100 mm×3.0 mm.

In this case, by changing the injection speed or the cooling rate, the front phase difference distribution of the molded resin layer was adjusted as shown in Table 3.

In the examples, the comparative examples, and the reference examples shown in Tables 3 and 4, regarding the front phase difference distribution of the molded resin layer, front phase differences of samples, obtained by dividing molded resin layers produced in the same manner into nine equal parts, were measured using AxoScan manufactured by Axometrics, Inc., and a difference between the maximum value and the minimum value was calculated as a front phase difference distribution.

Then, an optical pressure-sensitive adhesive film PDS1 manufactured by PANAC Corporation was bonded to a surface of the molded resin layer of the obtained molded body using a SEAL-type precision sheet bonding machine SE550aa (manufactured by CLIMB PRODUCTS CO., LTD.), and then using the same machine, a light-transmitting base material (first high-Re retardation film: front phase difference shown in Table 3) was bonded thereto or not to obtain half mirrors of Examples 1 to 6, 9, and 10, Comparative Examples 1 and 2, and Reference Examples 1 to 3.

### Production of Half Mirrors of Examples 12 to 15

Half mirrors of Examples 12 to 15 were produced in the same manner as in the production of the half mirror of Example 1, except that in place of the light-transmitting base material, a light-transmitting base material (first high-Re retardation film: front phase difference: 8,000 nm) in which the hard coat layer, the antiglare layer, the antireflection layer, and the antistatic layer were provided was used. The bonding to a pressure-sensitive adhesive film was performed such that the light-transmitting base material side was brought into contact with the pressure-sensitive adhesive film.

### <Production of Half Mirror of Example 11> (Single-Side in-Mold/Single-Side Insert Molding)

One side of a light-transmitting base material (first high-Re retardation film) having a front phase difference of 8,000 nm was coated with a heat sealing agent A-100 (manufactured by DIC) using a wire bar, and then dried to form a thermoplastic welding layer of 3.0 μm, and a light-transmitting base material (molding sheet) with a thermoplastic welding layer was obtained.

A mold composed of a combination of a concave mold and a convex mold was prepared as a mold for producing a flat plate. The light-transmitting base material with a thermoplastic welding layer was disposed such that the light-transmitting base material was in contact with the inner surface of the convex mold. On the concave mold, a temporary support (base film) of the same transfer sheet as that used in Example 1 was disposed in such a direction as to be in contact with the inner surface of the mold, and the transfer sheet was brought into contact with the bottom surface of the concave portion by vacuum suction. The mold was closed by combining both the molds, and a molten resin formed of PC (polycarbonate, IUPILON 53000) was injected between the light-transmitting base material and the transfer sheet in the mold, and molded (mold temperature: 90° C., resin temperature: 300° C., pressure: 100 MPa, time: 30 seconds). After cooling to room temperature, the mold was opened to take out the obtained molded body therefrom. The temporary support was peeled off, and the half mirror was obtained. The front phase difference distribution of the molded resin layer was adjusted as shown in Table 3 in the same manner as in Example 1.

### Production of Half Mirrors of Examples 7, 8, 16, 17, and 18

[Production of Molded Resin Layer]

A mold for producing a flat plate composed of a combination of a concave mold and a convex mold was closed, and a molten resin shown in Table 3 was injected and molded (mold temperature: 90° C., resin temperature: 300° C., pressure: 100 MPa, time: 30 seconds). After cooling to room temperature, the mold was opened, and the obtained molded resin layer (flat plate of 150 mm×100 mm×3 mm) was taken out therefrom.

In Table 3, PC which is the molten resin is IUPILON 53000, acryl is SUMIPEX MG5, PET is PETG K2012, and COP is ZEONEX E48R. The front phase difference distribution of the molded resin layer was adjusted as shown in Table 3 in the same manner as in Example 1.

An optical pressure-sensitive adhesive film PDS1 manufactured by PANAC Corporation was bonded to a main surface of one side of the obtained molded resin layer using a SEAL-type precision sheet bonding machine SE550aa (manufactured by CLIMB PRODUCTS CO., LTD.). Then, using the same machine, a circular polarization reflection plate B or a linear polarization reflection plate was bonded to a surface of the pressure-sensitive adhesive film. In this case, in a case of the circular polarization reflection plate B, the circular polarization reflection plate B was bonded such that the cholesteric liquid crystal layer side (opposite to the temporary support side) was brought into contact with the pressure-sensitive adhesive film, and the temporary support was peeled off. In a case of the linear polarization reflection plate, the linear polarization reflection plate was bonded such that an arbitrary surface thereof was brought into contact with the pressure-sensitive adhesive film, and the transmission axis of the linear polarization reflection film and the transmission axis of the display-side polarizing plate of the image display device were aligned.

An optical pressure-sensitive adhesive film PDS1 manufactured by PANAC Corporation was bonded to a surface of the molded resin layer opposite to the circular polarization reflection plate B or the linear polarization reflection plate using a SEAL-type precision sheet bonding machine SE550aa (manufactured by CLIMB PRODUCTS CO., LTD.), and then using the same machine, a light-transmitting base material (first high-Re retardation film: front phase difference: 8,000 nm) was bonded thereto.

### Production of Half Mirror of Comparative Example 3

An optical pressure-sensitive adhesive film PDS1 manufactured by PANAC Corporation was bonded to a main surface of one side of a molded resin layer obtained in the same manner as in Example 7 using a SEAL-type precision sheet bonding machine SE550aa (manufactured by CLIMB PRODUCTS CO., LTD.). Then, using the same machine, an optical pressure-sensitive adhesive film and a ¼ wavelength plate with a temporary support were bonded thereto. In this case, these were bonded such that the ¼ wavelength plate side (opposite to the temporary support side) was brought into contact with the pressure-sensitive adhesive film, and then the temporary support was peeled off.

Then, an optical pressure-sensitive adhesive film PDS1 manufactured by PANAC Corporation was bonded to a surface of the molded resin layer opposite to the surface on which the ¼ wavelength plate was provided using a SEAL-type precision sheet bonding machine SE550aa (manufactured by CLIMB PRODUCTS CO., LTD.), and then using the same machine, a light-transmitting base material (first high-Re retardation film: front phase difference: 8,000 nm) was bonded thereto.

An optical pressure-sensitive adhesive film PDS1 manufactured by PANAC Corporation was bonded to a surface of the light-transmitting base material using a SEAL-type precision sheet bonding machine SE550aa (manufactured by CLIMB PRODUCTS CO., LTD.), and then using the same machine, a circular polarization reflection plate A was bonded to the pressure-sensitive adhesive film. In this case, the circular polarization reflection plate A was bonded such that the cholesteric liquid crystal layer side (opposite to the temporary support side) was brought into contact with the pressure-sensitive adhesive film, and then the temporary support was peeled off.

### Production of Half Mirror of Comparative Example 4

An optical pressure-sensitive adhesive film PDS1 manufactured by PANAC Corporation was bonded to a main surface of one side of a molded resin layer obtained in the same manner as in Example 7 using a SEAL-type precision sheet bonding machine SE550aa (manufactured by CLIMB PRODUCTS CO., LTD.). Then, using the same machine, an optical pressure-sensitive adhesive film and a light-transmitting base material (first high-Re retardation film: front phase difference: 8,000 nm) were bonded thereto. An optical pressure-sensitive adhesive film PDS1 manufactured by PANAC Corporation was bonded to a surface of the light-transmitting base material using a SEAL-type precision sheet bonding machine SE550aa (manufactured by CLIMB PRODUCTS CO., LTD.), and then using the same machine, the optical pressure-sensitive adhesive film was bonded to a ¼ wavelength plate with a temporary support. In this case, these were bonded such that the ¼ wavelength plate side (opposite to the temporary support side) was brought into contact with the pressure-sensitive adhesive film, and then the temporary support was peeled off. An optical pressure-sensitive adhesive film PDS1 manufactured by PANAC Corporation was bonded to the peeling surface using a SEAL-type precision sheet bonding machine SE550aa (manufactured by CLIMB PRODUCTS CO., LTD.), and then using the same machine, a circular polarization reflection plate A was bonded thereto. In this case, the circular polarization reflection plate A was bonded such that the cholesteric liquid crystal layer side (opposite to the temporary support side) was brought into contact with the pressure-sensitive adhesive film, and then the temporary support was peeled off.

### Production of Half Mirrors of Example 19 and Reference Example 4

A surface of a light-transmitting base material (second high-Re retardation film: front phase difference: 4,000 nm) was coated with a heat sealing agent A-100 (manufactured by DIC) using a wire bar, and then dried to form a thermoplastic welding layer of 3.0 μm, and a molding sheet was obtained.

A mold composed of a combination of a concave mold and a convex mold was prepared as a mold for producing a flat plate. On the concave mold, the molding sheet was disposed in such a direction that the light-transmitting base material was in contact with the inner surface of the mold, and the molding sheet was brought into contact with the bottom surface of the concave portion by vacuum suction. The mold was closed by combining the concave mold with the convex mold, and in the formed space, a molten resin formed of PC (polycarbonate, IUPILON 53000) was injected into the mold so as to be in contact with a surface of the transfer sheet on the thermoplastic welding layer side, and molded (mold temperature: 90° C., resin temperature: 300° C., pressure: 100 MPa, time: 30 seconds). After cooling to room temperature, the mold was opened to take out the obtained molded body therefrom. The molded resin layer in the obtained molded body was a flat plate of 150 mm×100 mm×3.0 mm.

In this case, by adjusting the injection speed or the cooling rate, the front phase difference distribution of the molded resin layer was adjusted as shown in the table.

Then, an optical pressure-sensitive adhesive film PDS1 manufactured by PANAC Corporation was bonded to the light-transmitting base material (second high-Re retardation film) using a SEAL-type precision sheet bonding machine SE550aa (manufactured by CLIMB PRODUCTS CO., LTD.), and then using the same machine, a circular polarization reflection plate B was bonded thereto. In this case, in a case of the circular polarization reflection plate B, the circular polarization reflection plate B was bonded such that the cholesteric liquid crystal layer side (opposite to the temporary support side) was brought into contact with the pressure-sensitive adhesive film, and then the temporary support was peeled off.

An optical pressure-sensitive adhesive film PDS1 manufactured by PANAC Corporation was bonded to a surface of the molded resin layer opposite to the circular polarization reflection plate B using a SEAL-type precision sheet bonding machine SE550aa (manufactured by CLIMB PRODUCTS CO., LTD.), and then using the same machine, a light-transmitting base material (first high-Re retardation film, front phase difference: 4,000 nm) was bonded thereto such that the slow axis direction thereof and the slow axis direction of the second high-Re retardation film formed an angle shown in Table 4 to obtain half mirrors of Example 19 and Reference Example 4.

### Production of Half Mirror of Example 20

In the same manner as in Example 7, a mold for producing a flat plate composed of a combination of a concave mold and a convex mold was closed, and a molten resin shown in Table 4 was injected and molded (mold temperature: 90° C., resin temperature: 300° C., pressure: 100 MPa, time: 30 seconds). After cooling to room temperature, the mold was opened, and the obtained molded resin layer (flat plate of 150 mm×100 mm×3 mm) was taken out therefrom.

In Table 4, PC which is the molten resin is IUPILON 53000. The front phase difference distribution of the molded resin layer was adjusted as shown in the table in the same manner as in Example 1.

An optical pressure-sensitive adhesive film PDS1 manufactured by PANAC Corporation was bonded to a main surface of one side of the obtained molded resin layer using a SEAL-type precision sheet bonding machine SE550aa (manufactured by CLIMB PRODUCTS CO., LTD.). Then, using the same machine, a light-transmitting base material (second high-Re retardation film, front phase difference: 4,000 nm) was bonded to a surface of the pressure-sensitive adhesive film, and an optical pressure-sensitive adhesive film PDS1 manufactured by PANAC Corporation was bonded thereon using a SEAL-type precision sheet bonding machine SE550aa (manufactured by CLIMB PRODUCTS CO., LTD.). Then, using the same machine, a circular polarization reflection plate B was bonded thereto. In this case, in a case of the circular polarization reflection plate B, the circular polarization reflection plate B was bonded such that the cholesteric liquid crystal layer side (opposite to the temporary support side) was brought into contact with the pressure-sensitive adhesive film, and the temporary support was peeled off.

An optical pressure-sensitive adhesive film PDS1 manufactured by PANAC Corporation was bonded to a surface of the molded resin layer opposite to the circular polarization reflection plate B using a SEAL-type precision sheet bonding machine SE550aa (manufactured by CLIMB PRODUCTS CO., LTD.), and then using the same machine, a light-transmitting base material (first high-Re retardation film, front phase difference: 4,000 nm) was bonded thereto such that the slow axis direction thereof and the slow axis direction of the second high-Re retardation film formed an angle of 0° to obtain a half mirror of Example 20.

<Evaluation of Half Mirror>

[Evaluation of Color Unevenness of Image]

A half mirror was disposed on an image display surface of the following image display device so as to be parallel to the image display surface and to display a white image.

(Image Display Device)

Liquid Crystal Monitor White LED Type: (FLATORON E2260V (manufactured by LG Electronics Japan Inc.))

Fluorescent Lamp Type: (FLATORON W2240V (manufactured by LG Electronics Japan Inc.))

The position was set such that the angle formed between the slow axis of the light-transmitting base material and the polarization axis of the visible-side polarizer of the image display device was as shown in Tables 3 and 4 between 0° and 90° while the above parallel state was maintained. The image when a white image was displayed on the image display device was observed with polarizing sunglasses from the observation surface, and the presence or absence and the extent of occurrence of color unevenness were confirmed. These were evaluated according to the following criteria. The results are shown in Tables 3 and 4.

None: When observed from the front, there was no color unevenness, and thus there is no problem in visibility.

Occurred: Color unevenness was observed when observed from the front.

[Evaluation of Unevenness of Mirror-Reflected Image]

The position was set such that the angle formed between the slow axis of the light-transmitting base material and the polarization axis of the visible-side polarizer of the image display device was as shown in Table 3 between 0° and 90° as in the evaluation of the color unevenness of the image. The mirror-reflected image when the image display device was turned off was observed with polarizing sunglasses from the observation surface, and the presence or absence and the extent of occurrence of color unevenness were confirmed. These were evaluated according to the following criteria. The results are shown in Tables 3 and 4.

None: When observed from the front, there is no color unevenness, and thus there is no problem in visibility.

Occurred: Color unevenness was observed when observed from the front.

[Linearly Polarized Light Transmittance]

A linearly polarized light transmittance was measured using an ultraviolet-visible near infrared spectrophotometer V-670 manufactured by JASCO Corporation. The measurement of the transmittance for linearly polarized light was carried out by placing the linear polarizing plate on the light source side of the spectrophotometer such that the slow axis of the ¼ wavelength plate was at 45° with respect to the polarization transmission axis of the linear polarizing plate. The average of the natural light transmittance obtained as described above for linearly polarized light at 400 nm to 700 nm was calculated. A value of 80% or higher was regarded as good, and a value of less than 80% was regarded as defective. The results are shown in Tables 3 and 4.

TABLE 3

| | | | | Front Phase | | | |
|---|---|---|---|---|---|---|---|
| | | | Front Phase | Difference of | | | |
| | Molded | | Difference | Light-Transmitting | Optical | | Position of |
| | Resin | Molding | Distribution of | Base | Functional | Reflective Polarizing | Reflective |
| | Layer | Method | Molded Resin Layer | Material | Layer | Plate | Polarizing Plate |
| Example 1 | PC | Single | 250 nm | 8,000 nm | None | Circular Polarization | Between |
| | | In-Mold | | | | Reflection Plate B | |
| Example 2 | PC | Single | 100 nm | 8,000 nm | None | Circular Polarization | Between |
| | | In-Mold | | | | Reflection Plate B | |
| Example 3 | PC | Single | 500 nm | 8,000 nm | None | Circular Polarization | Between |
| | | In-Mold | | | | Reflection Plate B | |
| Example 4 | PC | Single | 250 nm | 5,000 nm | None | Circular Polarization | Between |
| | | In-Mold | | | | Reflection Plate B | |
| Example 5 | PC | Single | 250 nm | 3,000 nm | None | Circular Polarization | Between |
| | | In-Mold | | | | Reflection Plate B | |
| Example 6 | PC | Single | 250 nm | 10,000 nm | None | Circular Polarization | Between |
| | | In-Mold | | | | Reflection Plate B | |
| Comparative | PC | Single | 250 nm | There is no | None | Circular Polarization | Between |
| Example 1 | | In-Mold | | light-transmitting | | Reflection Plate B | |
| | | | | base material | | | |
| Comparative | PC | Single | 250 nm | 1,500 nm | None | Circular Polarization | Between |
| Example 2 | | In-Mold | | | | Reflection Plate B | |
| Example 7 | PC | Injection | 250 nm | 8,000 nm | None | Circular Polarization | Between |
| | | Molding | | | | Reflection Plate B | |
| Example 8 | PC | Injection | 250 nm | 8,000 nm | None | Linear Polarization | Between |
| | | Molding | | | | Reflection Plate | |
| Comparative | PC | Injection | 250 nm | 8,000 nm | None | Circular Polarization | Visual Side |
| Example 3 | | Molding | | | | Reflection Plate A | |
| Comparative | PC | Injection | 250 nm | 8,000 nm | None | Circular Polarization | Visual Side |
| Example 4 | | Molding | | | | Reflection Plate A | |
| Reference | PC | Single | 250 nm | 8,000 nm | None | Circular Polarization | Between |
| Example 1 | | In-Mold | | | | Reflection Plate B | |
| Example 9 | PC | Single | 250 nm | 8,000 nm | None | Circular Polarization | Between |
| | | In-Mold | | | | Reflection Plate B | |
| Example 10 | PC | Single | 250 nm | 8,000 nm | None | Circular Polarization | Between |
| | | In-Mold | | | | Reflection Plate B | |
| Reference | PC | Single | 250 nm | 8,000 nm | None | Circular Polarization | Between |
| Example 2 | | In-Mold | | | | Reflection Plate B | |
| Reference | PC | Single | 250 nm | 8,000 nm | None | Circular Polarization | Between |
| Example 3 | | In-Mold | | | | Reflection Plate B | |
| Example 11 | PC | Single-Side | 250 nm | 8,000 nm | None | Circular Polarization | Between |
| | | In-Mold/ | | | | Reflection Plate B | |
| | | Single-Side | | | | | |
| | | Insert | | | | | |
| Example 12 | PC | Single | 250 nm | 8,000 nm | HC | Circular Polarization | Between |
| | | In-Mold | | | | Reflection Plate B | |
| Example 13 | PC | Single | 250 nm | 8,000 nm | AG | Circular Polarization | Between |
| | | In-Mold | | | | Reflection Plate B | |
| Example 14 | PC | Single | 250 nm | 8,000 nm | AR | Circular Polarization | Between |
| | | In-Mold | | | | Reflection Plate B | |
| Example 15 | PC | Single | 250 nm | 8,000 nm | AS | Circular Polarization | Between |
| | | In-Mold | | | | Reflection Plate B | |
| Example 16 | PET | Injection | 250 nm | 8,000 nm | None | Circular Polarization | Between |
| | | Molding | | | | Reflection Plate B | |
| Example 17 | Acryl | Injection | 100 nm | 8,000 nm | None | Circular Polarization | Between |
| | | Molding | | | | Reflection Plate B | |
| Example 18 | COP | Injection | 100 nm | 8,000 nm | None | Circular Polarization | Between |
| | | Molding | | | | Reflection Plate B | |

| | | | Angle Between | | | |
|---|---|---|---|---|---|---|
| | | | Transmission Axis of Linear | | | |
| | | | Polarizer on Image Display | Color | Linearly | |
| | | | Side and Slow Axis of | Color | Unevenness of | Polarized |
| | Position of ¼ | Light Source of | Light-Transmitting Base | Unevenness of | Mirror-Reflected | Light |
| | Wavelength Plate | Backlight | Material | Image | Image | Transmittance |
| Example 1 | Between | White LED | 45° | None | None | Good |
| Example 2 | Between | White LED | 45° | None | None | Good |
| Example 3 | Between | White LED | 45° | None | None | Good |
| Example 4 | Between | White LED | 45° | None | None | Good |
| Example 5 | Between | White LED | 45° | None | None | Good |
| Example 6 | Between | White LED | 45° | None | None | Good |
| Comparative | Between | White LED | 45° | Occurred | Occurred | Good |
| Example 1 | | | | | | |
| Comparative | Between | White LED | 45° | Occurred | Occurred | Good |
| Example 2 | | | | | | |
| Example 7 | Between | White LED | 45° | None | None | Good |
| Example 8 | Between | White LED | 45° | None | None | Good |
| Comparative | Between | White LED | 45° | None | None | Defective |
| Example 3 | | | | | | |
| Comparative | Visual Side | White LED | 45° | None | None | Defective |
| Example 4 | | | | | | |
| Reference | Between | Fluorescent | 45° | Occurred | None | Good |
| Example 1 | | Lamp | | | | |
| Example 9 | Between | White LED | 30° | None | None | Good |
| Example 10 | Between | White LED | 60° | None | None | Good |
| Reference | Between | White LED | 0° | Occurred | None | Good |
| Example 2 | | | | | | |
| Reference | Between | White LED | 90° | Occurred | None | Good |
| Example 3 | | | | | | |
| Example 11 | Between | White LED | 45° | None | None | Good |
| Example 12 | Between | White LED | 45° | None | None | Good |
| Example 13 | Between | White LED | 45° | None | None | Good |
| Example 14 | Between | White LED | 45° | None | None | Good |
| Example 15 | Between | White LED | 45° | None | None | Good |
| Example 16 | Between | White LED | 45° | None | None | Good |
| Example 17 | Between | White LED | 45° | None | None | Good |
| Example 18 | Between | White LED | 45° | None | None | Good |

Position of Reflective Polarizing Plate
Between: Between the light-transmitting base material and the liquid crystal display device
Visible Side: Closer to the visible side than the light-transmitting base material
Position of ¼ Wavelength Plate Between: Between the reflective polarizing plate and the liquid crystal display device
Visible Side: Closer to the visible side than the light-transmitting base material

TABLE 4

| | | | | Total Front Phase | | | | |
|---|---|---|---|---|---|---|---|---|
| | | | | Difference of | | | | |
| | | | In-Plane | Light-Transmitting | | | | |
| | | | Phase | Base Material | | | | |
| | | | Difference | (first high-Re | | | Position | |
| | | | Distribution | retardation film | | | of | Position of |
| | Molded | | of Molded | and second | Optical | Reflective | Reflective | ¼ |
| | Resin | Molding | Resin | high-Re | Functional | Polarizing | Polarizing | Wavelength |
| Examples | Layer | Method | Layer | retardation film) | Layer | Plate | Plate | Plate |
| Example 19 | PC | Single | 250 nm | 8,000 nm | None | Circular | Between | Between |
| | | In-Mold | | | | Polarization | | |
| | | | | | | Reflection | | |
| | | | | | | Plate B | | |
| Example 20 | PC | Injection | 250 nm | 8,000 nm | None | Circular | Between | Between |
| | | Molding | | | | Polarization | | |
| | | | | | | Reflection | | |
| | | | | | | Plate B | | |
| Reference | PC | Single | 250 nm | 8,000 nm | None | Circular | Between | Between |
| Example 4 | | In-Mold | | | | Polarization | | |
| | | | | | | Reflection | | |
| | | | | | | Plate B | | |

| | | Angle | | | | |
|---|---|---|---|---|---|---|
| | | Between | Angle | | | |
| | | Transmission | Between | | | |
| | | Axis of | Slow Axis | | | |
| | | Linear | of First | | | |
| | | Polarizer on | High-Re | | | |
| | | Image | Retardation | | | |
| | | Display Side | Film and | | | |
| | | and Slow | Slow Axis | | | |
| | | Axis of First | of Second | | | Linearly |
| | Light | High-Re | High-Re | | Unevenness of | Polarized |
| | Source of | Retardation | Retardation | Unevenness | Mirror-Reflected | Light |
| Examples | Backlight | Film | Film | of Image | Image | Transmittance |
| Example 19 | White | 45° | 0° | None | None | Good |
| | LED | | | | | |
| Example 20 | White | 45° | 0° | None | None | Good |
| | LED | | | | | |
| Reference | White | 45° | 45° | Occurred | None | Good |
| Example 4 | LED | | | | | |

Position of Reflective Polarizing Plate
Between: Between the light-transmitting base material (first high-Re retardation film) and the liquid crystal display device.
Position of ¼ Wavelength Plate
Between: Between the reflective polarizing plate and the liquid crystal display device

What is claimed is:

1. A half mirror comprising in order:
an observation surface;
a molded resin layer; and
a polarization reflection plate,
wherein at least one high-Re retardation film is included between the observation surface and the polarization reflection plate, and a total front phase difference of the high-Re retardation film is 3,000 nm or greater, and
a first high-Re retardation film is included as the high-Re retardation film between the observation surface and the molded resin layer.

2. The half mirror according to claim 1,
wherein a front phase difference distribution of the molded resin layer is 100 nm or greater.

3. The half mirror according to claim 1,
wherein a total front phase difference of the high-Re retardation film is 5,000 nm or greater.

4. The half mirror according to claim 1,
wherein a front phase difference of the first high-Re retardation film is 3,000 nm or greater.

5. The half mirror according to claim 1,
wherein only the first high-Re retardation film is included as the high-Re retardation film.

6. The half mirror according to claim 1,
wherein as the high-Re retardation film, a second high-Re retardation film is further included between the molded resin layer and the polarization reflection plate.

7. The half mirror according to claim 6,
wherein a slow axis direction of the first high-Re retardation film is the same as a slow axis direction of the second high-Re retardation film.

8. The half mirror according to claim 6,
wherein an adhesive layer or a thermoplastic welding layer is included between the second high-Re retardation film and the molded resin layer.

9. The half mirror according to claim 1,
wherein the molded resin layer includes at least one polymer selected from the group consisting of polycarbonate, poly(meth)acrylate, polyester, and a cycloolefin polymer.

10. The half mirror according to claim 1,
wherein the polarization reflection plate is a circular polarization reflection layer.

11. The half mirror according to claim 10,
wherein the circular polarization reflection layer includes a cholesteric liquid crystal layer.

12. The half mirror according to claim 11,
wherein the circular polarization reflection layer includes three or more cholesteric liquid crystal layers.

13. The half mirror according to claim 10, further comprising:
a ¼ wavelength plate,
wherein the molded resin layer, the polarization reflection plate, and the ¼ wavelength plate are included in this order.

14. The half mirror according to claim 13,
wherein the polarization reflection plate and the ¼ wavelength plate are in direct contact with each other.

15. The half mirror according to claim 1,
wherein an adhesive layer or a thermoplastic welding layer is included between the molded resin layer and the polarization reflection plate.

16. The half mirror according to claim 1,
wherein an adhesive layer or a thermoplastic welding layer is included between the first high-Re retardation film and the molded resin layer.

17. A mirror with an image display function comprising:
the half mirror according to claim 1; and
an image display device,
wherein the observation surface, the molded resin layer, the polarization reflection plate, and the image display device are disposed in this order.

18. The mirror with an image display function according to claim 17,
wherein the image display device emits linearly polarized light to form an image,
the image display device has a backlight which provides a continuous emission spectrum, and
a slow axis of the first high-Re retardation film forms an angle of 30° to 60° with a polarization direction of the linearly polarized light.

19. The mirror with an image display function according to claim 18,
wherein the image display device is a liquid crystal display device, and the backlight is a white LED.
